(19) United States
(12) Patent Application Publication
(10) Pub. No.: US 2017/0085514 A1
(43) Pub. Date: Mar. 23, 2017

(54) METHODS AND APPARATUSES FOR USING NETWORK-BASED DEVICES TO IMPROVE EDUCATOR/PARENT COMMUNICATION

(71) Applicant: EDUCATRX INC., Monroe, NC (US)

(72) Inventors: Tony Burrus, Monroe, NC (US); Tony Burrus, JR., Monroe, NC (US); Mary Brooks Ellis, Monroe, NC (US); Michael Rudolph Webb, Monroe, NC (US); Jason Mooneyham, Raleigh, NC (US)

(21) Appl. No.: 15/272,690

(22) Filed: Sep. 22, 2016

Related U.S. Application Data
(60) Provisional application No. 62/221,940, filed on Sep. 22, 2015.

(51) Int. Cl. H04L 12/58; G06Q 50/20; G06F 3/0482; G06Q 20/40

(52) U.S. Cl. CPC H04L 51/24; H04L 51/14; G06Q 20/40; G06Q 50/205; G06F 3/0482

(57) ABSTRACT

Embodiments are disclosed for facilitating Internet-based communication between educators and parents. In the context of a method, an example embodiment includes populating a database with one or more communications associated with one or more students and categorized within one or more alert categories, and one or more action plans associated with one or more parents and at least one of the one or more alert categories. The method includes detecting occurrence of a triggering event corresponding to a particular communication in the database, and identifying one or more parents impacted by the particular communication. The method thereafter includes retrieving one or more action plans for the one or more parents impacted by the particular communication, and causing transmission of one or more notification messages based on the retrieved one or more action plans. A corresponding apparatus and computer program product are also provided.

### CROSS-REFERENCE TO RELATED APPLICATIONS

This application claims the benefit of U.S. Provisional Patent Application No. 62/221,940, filed Sep. 22, 2015, the entire disclosure of which is incorporated herein by reference.

### TECHNOLOGICAL FIELD

Example embodiments of the present invention relate generally to network-based communications and, more particularly, to methods and apparatuses for utilizing customizable action plans to streamline network-based notifications.

### BACKGROUND

Applicant has discovered problems with traditional methods by which teachers and administrators in a school system communicate with the parents of the students they oversee. Many of these problems are overcome using example embodiments described in detail below, which rely upon previously unavailable technological improvements to address pain points and minimize administrative hassle.

### BRIEF SUMMARY

As described herein, example embodiments provide a platform enabling users to seamlessly orchestrate communication via web-based communication services of their choosing, create, store, and circulate personal forms, and transmit or receive customized notifications via the platform itself or via the web-based communication services in accordance with customizable action plans.

In a first example embodiment, a method is provided for facilitating Internet-based communication between educators and parents who are located remotely from each other. The method includes populating a database with one or more communications associated with one or more students and categorized within one or more alert categories, wherein each of the one or more communications comprises a notification or a form, one or more action plans associated with one or more parents and at least one of the one or more alert categories, and correlations of each of the one or more students to at least one of the one or more parents. The method further includes detecting, by a processor, occurrence of a triggering event corresponding to a particular communication in the database, identifying one or more parents impacted by the particular communication, retrieving one or more action plans based on the one or more parents impacted by the particular communication and an alert category into which the particular communication is categorized, and causing, by the processor, transmission of one or more notification messages based on the retrieved one or more action plans.

In some embodiments, the method includes receiving one or more transmission from one or more parent devices in response to transmission of the one or more notification messages. In some such embodiments, the method includes, in an instance in which a transmission from a parent device authorizes payment for a student activity, causing a charge to be applied to an account associated with the parent device. Additionally or alternatively, the method includes, in an instance in which a transmission from a parent device authorizes performance of a student activity, storing an indication that a parent associated with the parent device has authorized performance of the student activity.

In some embodiments, populating the database includes receiving, the one or more communications from one or more educator devices, identifying triggering events corresponding to the received one or more communications, storing, in the database, the received one or more communications, one or more indications of the one or more students associated with the one or more communications, one or more indications of the alert categories within which the one or more communications are categorized, and one or more indications of the identified triggering events corresponding to the received one or more communications, receiving the one or more action plans from one or more parent devices, storing the one or more action plans in the database in association with the one or more parents and the at least one of the one or more alert categories, receiving the correlations of the one or more students to at least one of the one or more parents from one or more educator devices, and storing the received correlations in the database. In this regard, receiving the action plan may include causing a parent device to display an action plan generation interface, wherein the action plan generation interface is configured to prompt the parent device to select one or more notification methods for a chosen alert category, and receiving, from the parent device, selection of a set of notification methods for the chosen alert category, wherein the set of notification methods for the chosen alert category comprises the action plan.

In some embodiments, a triggering event comprises at least one of: occurrence of a user-defined date; occurrence of a date that is a predefined number of days after the user-defined date; or occurrence of a date a predefined number of days before a student activity requiring parent authorization.

In some embodiments, detecting the occurrence of the triggering event corresponding to the particular communication includes retrieving a current date, identifying whether the current date comprises a triggering event corresponding to any communication stored in the database, and determining that the current date comprises a triggering event corresponding to the particular communication.

In some embodiments, identifying the one or more parents impacted by the particular communication includes retrieving the one or more students associated with the particular communication, and identifying the one or more parents impacted by the particular communication using the correlations of the one or more students to at least one of the one or more parents.

In some embodiments, causing transmission of the one or more notification messages includes, for each of the retrieved one or more action plans: identifying, from the action plan, a set of notification methods, and for each notification method of the set of notification methods, identifying, from the action plan, one or more target recipients for the notification method, generating notification messages for the one or more target recipients based on the particular communication, and transmitting the generated notification messages to the one or more target recipients using the notification method.

In another example embodiment, an apparatus is provided for facilitating Internet-based communication between educators and parents who are located remotely from each other. The apparatus includes at least one processor and at least one memory storing computer-executable instructions, that, when executed by the at least one processor, cause the apparatus to populate a database with one or more communications associated with one or more students and categorized within one or more alert categories, wherein each of the one or more communications comprises a notification or a form, one or more action plans associated with one or more parents and at least one of the one or more alert categories, and correlations of each of the one or more students to at least one of the one or more parents. The computer-executable instructions, when executed by the at least one processor, further cause the apparatus to detect occurrence of a triggering event corresponding to a particular communication in the database, identify one or more parents impacted by the particular communication, retrieve one or more action plans based on the one or more parents impacted by the particular communication and an alert category into which the particular communication is categorized, and cause transmission of one or more notification messages based on the retrieved one or more action plans.

In some embodiments, the computer-executable instructions, when executed by the at least one processor, further cause the apparatus to receive one or more transmission from one or more parent devices in response to transmission of the one or more notification messages. In some such embodiments, the computer-executable instructions, when executed by the at least one processor, further cause the apparatus to, in an instance in which a transmission from a parent device authorizes payment for a student activity, cause a charge to be applied to an account associated with the parent device. Additionally or alternatively, the computer-executable instructions, when executed by the at least one processor, further cause the apparatus to, in an instance in which a transmission from a parent device authorizes performance of a student activity, store an indication that a parent associated with the parent device has authorized performance of the student activity.

In some embodiments, the computer-executable instructions, when executed by the at least one processor, cause the apparatus to populate the database by receiving, the one or more communications from one or more educator devices, identifying triggering events corresponding to the received one or more communications, storing, in the database, the received one or more communications, one or more indications of the one or more students associated with the one or more communications, one or more indications of the alert categories within which the one or more communications are categorized, and one or more indications of the identified triggering events corresponding to the received one or more communications, receiving the one or more action plans from one or more parent devices, storing the one or more action plans in the database in association with the one or more parents and the at least one of the one or more alert categories, receiving the correlations of the one or more students to at least one of the one or more parents from one or more educator devices, and storing the received correlations in the database. In this regard, the computer-executable instructions, when executed by the at least one processor, may cause the apparatus to receive an action plan by causing a parent device to display an action plan generation interface, wherein the action plan generation interface is configured to prompt the parent device to select one or more notification methods for a chosen alert category, and receiving, from the parent device, selection of a set of notification methods for the chosen alert category, wherein the set of notification methods for the chosen alert category comprises the action plan.

In some embodiments, a triggering event comprises at least one of: occurrence of a user-defined date; occurrence of a date that is a predefined number of days after the user-defined date; or occurrence of a date a predefined number of days before a student activity requiring parent authorization.

In some embodiments, the computer-executable instructions, when executed by the at least one processor, further cause the apparatus to detect the occurrence of the triggering event corresponding to the particular communication by retrieving a current date, identifying whether the current date comprises a triggering event corresponding to any communication stored in the database, and determining that the current date comprises a triggering event corresponding to the particular communication.

In some embodiments, the computer-executable instructions, when executed by the at least one processor, further cause the apparatus to identify the one or more parents impacted by the particular communication by retrieving the one or more students associated with the particular communication, and identifying the one or more parents impacted by the particular communication using the correlations of the one or more students to at least one of the one or more parents.

In some embodiments, the computer-executable instructions, when executed by the at least one processor, further cause the apparatus to cause transmission of the one or more notification messages by, for each of the retrieved one or more action plans, identifying, from the action plan, a set of notification methods, and for each notification method of the set of notification methods, identifying, from the action plan, one or more target recipients for the notification method, generating notification messages for the one or more target recipients based on the particular communication, and transmitting the generated notification messages to the one or more target recipients using the notification method.

In another example embodiment, at least one non-transitory computer-readable storage medium is provided for facilitating Internet-based communication between educators and parents who are located remotely from each other. The at least one non-transitory computer-readable storage medium store computer-executable instructions that, when executed, cause an apparatus to populate a database with one or more communications associated with one or more students and categorized within one or more alert categories, wherein each of the one or more communications comprises a notification or a form, one or more action plans associated with one or more parents and at least one of the one or more alert categories, and correlations of each of the one or more students to at least one of the one or more parents. The computer-executable instructions, when executed, may cause the apparatus to detect occurrence of a triggering event corresponding to a particular communication in the database, identify one or more parents impacted by the particular communication, retrieve one or more action plans based on the one or more parents impacted by the particular communication and an alert category into which the particular communication is categorized, and cause, by the processor, transmission of one or more notification messages based on the retrieved one or more action plans.

In some embodiments, the computer-executable instructions, when executed, further cause the apparatus to receive one or more transmission from one or more parent devices in response to transmission of the one or more notification messages. In some such embodiments, the computer-executable instructions, when executed, further cause the apparatus to, in an instance in which a transmission from a parent device authorizes payment for a student activity, cause a charge to be applied to an account associated with the parent device. Additionally or alternatively, the computer-executable instructions, when executed, further cause the apparatus to, in an instance in which a transmission from a parent device authorizes performance of a student activity, store an indication that a parent associated with the parent device has authorized performance of the student activity.

In some embodiments, the computer-executable instructions, when executed, further cause the apparatus to populate the database by receiving, the one or more communications from one or more educator devices, identifying triggering events corresponding to the received one or more communications, storing, in the database, the received one or more communications, one or more indications of the one or more students associated with the one or more communications, one or more indications of the alert categories within which the one or more communications are categorized, and one or more indications of the identified triggering events corresponding to the received one or more communications receiving the one or more action plans from one or more parent devices, storing the one or more action plans in the database in association with the one or more parents and the at least one of the one or more alert categories, receiving the correlations of the one or more students to at least one of the one or more parents from one or more educator devices, and storing the received correlations in the database. In this regard, the computer-executable instructions, when executed, may further cause the apparatus to receive the action plan by causing a parent device to display an action plan generation interface, wherein the action plan generation interface is configured to prompt the parent device to select one or more notification methods for a chosen alert category, and receiving, from the parent device, selection of a set of notification methods for the chosen alert category, wherein the set of notification methods for the chosen alert category comprises the action plan.

In some embodiments, a triggering event comprises at least one of: occurrence of a user-defined date; occurrence of a date that is a predefined number of days after the user-defined date; or occurrence of a date a predefined number of days before a student activity requiring parent authorization.

In some embodiments, the computer-executable instructions, when executed, further cause the apparatus to detect the occurrence of the triggering event corresponding to the particular communication by retrieving a current date, identifying whether the current date comprises a triggering event corresponding to any communication stored in the database, and determining that the current date comprises a triggering event corresponding to the particular communication.

In some embodiments, the computer-executable instructions, when executed, further cause the apparatus to identify the one or more parents impacted by the particular communication by retrieving the one or more students associated with the particular communication, and identifying the one or more parents impacted by the particular communication using the correlations of the one or more students to at least one of the one or more parents.

In some embodiments, the computer-executable instructions, when executed, further cause the apparatus to cause transmission of the one or more notification messages by, for each of the retrieved one or more action plans, identifying, from the action plan, a set of notification methods, and for each notification method of the set of notification methods, identifying, from the action plan, one or more target recipients for the notification method, generating notification messages for the one or more target recipients based on the particular communication, and transmitting the generated notification messages to the one or more target recipients using the notification method.

In another example embodiment, an apparatus is provided for facilitating Internet-based communication between educators and parents who are located remotely from each other. The apparatus includes means for populating a database with one or more communications associated with one or more students and categorized within one or more alert categories, wherein each of the one or more communications comprises a notification or a form, one or more action plans associated with one or more parents and at least one of the one or more alert categories, and correlations of each of the one or more students to at least one of the one or more parents. The apparatus further includes means for detecting occurrence of a triggering event corresponding to a particular communication in the database, means for identifying one or more parents impacted by the particular communication, means for retrieving one or more action plans based on the one or more parents impacted by the particular communication and an alert category into which the particular communication is categorized, and means for causing transmission of one or more notification messages based on the retrieved one or more action plans.

In some embodiments, the apparatus includes means for receiving one or more transmission from one or more parent devices in response to transmission of the one or more notification messages. In some such embodiments, the apparatus includes means for, in an instance in which a transmission from a parent device authorizes payment for a student activity, causing a charge to be applied to an account associated with the parent device. Additionally or alternatively, the apparatus includes means for, in an instance in which a transmission from a parent device authorizes performance of a student activity, storing an indication that a parent associated with the parent device has authorized performance of the student activity.

In some embodiments, the means for populating the database includes means for receiving the one or more communications from one or more educator devices, means for identifying triggering events corresponding to the received one or more communications, means for storing, in the database, the received one or more communications, one or more indications of the one or more students associated with the one or more communications, one or more indications of the alert categories within which the one or more communications are categorized, and one or more indications of the identified triggering events corresponding to the received one or more communications, receiving the one or more action plans from one or more parent devices, means for storing the one or more action plans in the database in association with the one or more parents and the at least one of the one or more alert categories, means for receiving the correlations of the one or more students to at least one of the one or more parents from one or more educator devices, and means for storing the received correlations in the database. In this regard, the means for receiving the action plan may include means for causing a parent device to display an action plan generation interface, wherein the action plan generation interface is configured to prompt the parent device to select one or more notification methods for a chosen alert category, and means for receiving, from the parent device, selection of a set of notification methods for the chosen alert category, wherein the set of notification methods for the chosen alert category comprises the action plan.

In some embodiments, a triggering event comprises at least one of: occurrence of a user-defined date; occurrence of a date that is a predefined number of days after the user-defined date; or occurrence of a date a predefined number of days before a student activity requiring parent authorization.

In some embodiments, the means for detecting the occurrence of the triggering event corresponding to the particular communication includes means for retrieving a current date, means for identifying whether the current date comprises a triggering event corresponding to any communication stored in the database, and means for determining that the current date comprises a triggering event corresponding to the particular communication.

In some embodiments, the means for identifying the one or more parents impacted by the particular communication includes means for retrieving the one or more students associated with the particular communication, and means for identifying the one or more parents impacted by the particular communication using the correlations of the one or more students to at least one of the one or more parents.

In some embodiments, the means for causing transmission of the one or more notification messages includes, for each of the retrieved one or more action plans: means for identifying, from the action plan, a set of notification methods, and for each notification method of the set of notification methods, means for identifying, from the action plan, one or more target recipients for the notification method, means for generating notification messages for the one or more target recipients based on the particular communication, and means for transmitting the generated notification messages to the one or more target recipients using the notification method.

In another example embodiment, a method is provided for facilitating Internet-based communication between an educator and one or more remote parents. The method includes generating, by an educator device associated with the educator, a communication comprising a notification or a form, wherein the communication is categorized within one or more alert categories, receiving, by input/output circuitry of the educator device, identification of one or more students associated with the generated communication, transmitting, by communications circuitry of the educator device and to a server device, the generated communication and an indication of the one or more students associated with the generated communication, and receiving an indication regarding whether one or more parents impacted by the generated communication have transmitted a response to the generated communication.

In some embodiments, the method includes displaying, by the input/output circuitry of the educator device, an interface illustrating whether the one or more parents impacted by the generated communication have transmitted a response to the generated communication. In some such embodiments, in an instance in which the generated communication requested payment for a student activity, the interface further illustrates whether the one or more parents impacted by the generated communication have provided payment for the student activity. Additionally or alternatively, in an instance in which the generated communication requires authorization for the one or more students to perform a student activity, the interface may further illustrate whether the one or more parents impacted by the generated communication have provided authorization for corresponding students to perform the student activity.

In some embodiments, the method includes transmitting, by communications circuitry of the educator device and to the server device, an indication of correlations between the one or more students and one or more parents, wherein the correlations between the one or more students and the one or more parents enables identification of the one or more parents impacted by the generated communication.

In some embodiments, the method includes receiving selection of a triggering event for the generated communication, wherein transmitting the generated communication and the indication of the one or more students associated with the generated communication includes transmitting the selected triggering event. In some such embodiments, selection of the triggering event comprises selecting a user-defined date that, when detected by the server device, prompts transmission of the notification messages to the one or more parents impacted by the generated communication.

In another example embodiment, an educator device associated with an educator is provided for facilitating Internet-based communication between the educator and one or more remote parents. The educator device includes at least one processor and at least one memory storing computer-executable instructions, that, when executed by the at least one processor, cause the educator device to generate a communication comprising a notification or a form, wherein the communication is categorized within one or more alert categories, receive identification of one or more students associated with the generated communication, transmit, to a server device, the generated communication and an indication of the one or more students associated with the generated communication, and receive an indication regarding whether one or more parents impacted by the generated communication have transmitted a response to the generated communication.

In some embodiments, the computer-executable instructions, when executed by the at least one processor, further cause the educator device to display an interface illustrating whether the one or more parents impacted by the generated communication have transmitted a response to the generated communication. In some such embodiments, in an instance in which the generated communication requested payment for a student activity, the interface may further illustrates whether the one or more parents impacted by the generated communication have provided payment for the student activity. Additionally or alternatively, in an instance in which the generated communication requires authorization for the one or more students to perform a student activity, the interface may further illustrate whether the one or more parents impacted by the generated communication have provided authorization for corresponding students to perform the student activity.

In some embodiments, the computer-executable instructions, when executed by the at least one processor, further cause the educator device to transmit, to the server device, an indication of correlations between the one or more students and one or more parents, wherein the correlations between the one or more students and the one or more parents enables identification of the one or more parents impacted by the generated communication.

In some embodiments, the computer-executable instructions, when executed by the at least one processor, further cause the educator device to receive selection of a triggering event for the generated communication, wherein transmitting the generated communication and the indication of the one or more students associated with the generated communication includes transmitting the selected triggering event. In some such embodiments, the computer-executable instructions, when executed by the at least one processor, further cause the educator device to select the triggering event by selecting a user-defined date that, when detected by the server device, prompts transmission of the notification messages to the one or more parents impacted by the generated communication.

In another example embodiment, at least one non-transitory computer-readable storage medium for facilitating Internet-based communication between an educator and one or more remote parents. The at least one non-transitory computer-readable storage medium storing computer-executable instructions that, when executed, cause an educator device to generate a communication comprising a notification or a form, wherein the communication is categorized within one or more alert categories, receive identification of one or more students associated with the generated communication, transmit, to a server device, the generated communication and an indication of the one or more students associated with the generated communication, and receive an indication regarding whether one or more parents impacted by the generated communication have transmitted a response to the generated communication.

In some embodiments, the computer-executable instructions, when executed, further cause the educator device to display an interface illustrating whether the one or more parents impacted by the generated communication have transmitted a response to the generated communication. In some such embodiments, in an instance in which the generated communication requested payment for a student activity, the interface further illustrates whether the one or more parents impacted by the generated communication have provided payment for the student activity. Additionally or alternatively, in an instance in which the generated communication requires authorization for the one or more students to perform a student activity, the interface may further illustrate whether the one or more parents impacted by the generated communication have provided authorization for corresponding students to perform the student activity.

In some embodiments, the computer-executable instructions, when executed, further cause the apparatus to transmit, to the server device, an indication of correlations between the one or more students and one or more parents, wherein the correlations between the one or more students and the one or more parents enables identification of the one or more parents impacted by the generated communication.

In some embodiments, the computer-executable instructions, when executed, further cause the apparatus to receive selection of a triggering event for the generated communication, wherein transmitting the generated communication and the indication of the one or more students associated with the generated communication includes transmitting the selected triggering event. In some such embodiments, the computer-executable instructions, when executed, further cause the apparatus to select of the triggering event by selecting a user-defined date that, when detected by the server device, prompts transmission of the notification messages to the one or more parents impacted by the generated communication.

In another example embodiment, an educator device associated with an educator is provided for facilitating Internet-based communication between the educator and one or more remote parents. The apparatus includes means for generating a communication comprising a notification or a form, wherein the communication is categorized within one or more alert categories, means for receiving identification of one or more students associated with the generated communication, means for transmitting the generated communication and an indication of the one or more students associated with the generated communication, and means for receiving an indication regarding whether one or more parents impacted by the generated communication have transmitted a response to the generated communication.

In some embodiments, the educator device further includes means for displaying an interface illustrating whether the one or more parents impacted by the generated communication have transmitted a response to the generated communication. In some such embodiments, in an instance in which the generated communication requested payment for a student activity, the interface further illustrates whether the one or more parents impacted by the generated communication have provided payment for the student activity. Additionally or alternatively, in an instance in which the generated communication requires authorization for the one or more students to perform a student activity, the interface may further illustrate whether the one or more parents impacted by the generated communication have provided authorization for corresponding students to perform the student activity.

In some embodiments, the educator device includes means for transmitting, to the server device, an indication of correlations between the one or more students and one or more parents, wherein the correlations between the one or more students and the one or more parents enables identification of the one or more parents impacted by the generated communication.

In some embodiments, the apparatus includes means for receiving selection of a triggering event for the generated communication, wherein transmitting the generated communication and the indication of the one or more students associated with the generated communication includes transmitting the selected triggering event. In some such embodiments, the means for selecting the triggering event comprises means for selecting a user-defined date that, when detected by the server device, prompts transmission of the notification messages to the one or more parents impacted by the generated communication.

In another example embodiment, a method is provided for facilitating Internet-based communication between a parent and one or more remote educators. The method includes generating, by a processor of a first parent device associated with the parent, an action plan for the parent and associated with an alert category, transmitting, by communications circuitry of the first parent device, the action plan to a server device; and receiving, by a second parent device associated with the parent, a notification message based on a communication within the alert category and about a student associated with the parent, wherein the notification message is transmitted in response to generation of a communication by an educator.

In some embodiments, the method includes generating, by a processor of the second parent device, a message responsive to the received notification message, and transmitting, by communications circuitry of the second parent device and to the server device, the message responsive to the received notification message. In some such embodiments, the message responsive to the received notification message authorizes payment for a student activity identified in the received notification message. Additionally or alternatively, the message responsive to the received notification message authorizes performance of a student activity identified in the received notification message.

In some embodiments, generating the action plan associated with the alert category includes displaying, by input/output circuitry of the first parent device, an action plan generation interface, wherein the action plan generation interface is configured to prompt the parent device to select one or more notification methods for a chosen alert category, receiving, by the input/output circuitry of the first parent device, selection of a set of notification methods for the chosen alert category, and assembling the action plan, by the processor of the first parent device, wherein the action plan includes the set of notification methods for the chosen alert category.

In some embodiments, the first parent device comprises the second parent device. In other embodiments, the first parent device and the second parent device are different from each other. Either way, the second parent device may be a mobile device.

In another example embodiment, a system is provided for facilitating Internet-based communication between a parent and one or more remote educators. The system includes a first parent device associated with the parent and comprising at least one processor and at least one memory storing computer-executable instructions, that, when executed by the at least one processor, cause the first parent device to generate an action plan for the parent and associated with an alert category, and transmit the action plan to a server device, wherein the system further includes a second parent device associated with the parent and configured to receive a notification message based on a communication within the alert category and about a student associated with the parent, wherein the notification message is transmitted in response to generation of a communication by an educator.

In some embodiments, the second parent device is further configured to generate a message responsive to the received notification message, and transmit, to the server device, the message responsive to the received notification message. In some such embodiments, the message responsive to the received notification message authorizes payment for a student activity identified in the received notification message. Additionally or alternatively, the message responsive to the received notification message authorizes performance of a student activity identified in the received notification message.

In some embodiments, the computer-executable instructions, when executed by the at least one processor, cause the first parent device to generate the action plan associated with the alert category by displaying an action plan generation interface, wherein the action plan generation interface is configured to prompt the parent device to select one or more notification methods for a chosen alert category, receiving selection of a set of notification methods for the chosen alert category, and assembling the action plan, wherein the action plan includes the set of notification methods for the chosen alert category.

In some embodiments, the first parent device comprises the second parent device. Alternatively, the first parent device and the second parent device are different from each other. In either case, the second device may be a mobile device.

In another example embodiment, a non-transitory computer-readable storage medium is provided for facilitating Internet-based communication between a parent and one or more remote educators. The at least one non-transitory computer-readable storage medium stores computer-executable instructions that, when executed, cause a first parent device associated with the parent to generate an action plan for the parent and associated with an alert category, and transmit the action plan to a server device, wherein the computer-executable instructions, when executed, further cause a second parent device associated with the parent to receive a notification message based on a communication within the alert category and about a student associated with the parent, wherein the notification message is transmitted in response to generation of a communication by an educator.

In some embodiments, the computer-executable instructions, when executed, cause the second parent device to generate a message responsive to the received notification message, and transmit, to the server device, the message responsive to the received notification message. In this regard, the message responsive to the received notification message may authorize payment for a student activity identified in the received notification message. Additionally or alternatively, the message responsive to the received notification message may authorize performance of a student activity identified in the received notification message.

In some embodiments, the computer-executable instructions, when executed, cause the first parent device to generate the action plan associated with the alert category by displaying an action plan generation interface, wherein the action plan generation interface is configured to prompt the parent device to select one or more notification methods for a chosen alert category, receiving selection of a set of notification methods for the chosen alert category, and assembling the action plan, wherein the action plan includes the set of notification methods for the chosen alert category.

In some embodiments, the first parent device comprises the second parent device. Alternatively, the first parent device and the second parent device are different from each other. In either case, the second device may be a mobile device.

In another example embodiment, a system is provided for facilitating Internet-based communication between a parent and one or more remote educators. The system includes means for generating, by a first parent device associated with the parent, an action plan for the parent and associated with an alert category, means for transmitting, by the first parent device, the action plan to a server device; and means for receiving, by a second parent device associated with the parent, a notification message based on a communication within the alert category and about a student associated with the parent, wherein the notification message is transmitted in response to generation of a communication by an educator.

In some embodiments, the apparatus includes means for generating, by the second parent device, a message responsive to the received notification message, and means for transmitting, by the second parent device and to the server device, the message responsive to the received notification message. In some such embodiments, the message responsive to the received notification message authorizes payment for a student activity identified in the received notification message. Additionally or alternatively, the message responsive to the received notification message authorizes performance of a student activity identified in the received notification message.

In some embodiments, the means for generating the action plan associated with the alert category includes means for displaying, by the first parent device, an action plan generation interface, wherein the action plan generation interface is configured to prompt the parent device to select one or more notification methods for a chosen alert category, means for receiving, by the first parent device, selection of a set of notification methods for the chosen alert category, and means for assembling the action plan by the first parent device, wherein the action plan includes the set of notification methods for the chosen alert category.

In some embodiments, the first parent device comprises the second parent device. In other embodiments, the first parent device and the second parent device are different from each other. Either way, the second parent device may be a mobile device.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings, which are not necessarily drawn to scale, and wherein:

FIG. 1 shows an example system diagram, in accordance with an example embodiment of the present invention;

FIG. 2 illustrates a schematic block diagram of circuitry embodying a server device, in accordance with some example embodiments described herein;

FIG. 3 illustrates a schematic block diagram of circuitry embodying an educator device, in accordance with some example embodiments described herein;

FIG. 4 illustrates a schematic block diagram of circuitry embodying a parent device, in accordance with some example embodiments described herein;

FIGS. 5A-5F illustrate a series of user interfaces provided by a parent device comprising a mobile device, in accordance with some example embodiments described herein;

FIG. 6 illustrates a dashboard user interface provided, in accordance with some example embodiments described herein;

FIGS. 7A-7E illustrate a series of user interfaces provided by a parent device to facilitate generation of an action plan, in accordance with some example embodiments described herein;

FIG. 8 illustrates a flowchart describing example operations for facilitating Internet-based communication between educators and parents who are located remotely from each other, in accordance with some example embodiments described herein;

FIG. 9 illustrates a flowchart describing example operations for facilitating Internet-based communication between an educator and one or more remote parents, in accordance with some example embodiments described herein;

FIG. 10 illustrates a flowchart describing example operations for facilitating Internet-based communication between a parent and one or more remote educators, in accordance with some example embodiments described herein;

FIG. 11 illustrates an example user interface enabling the generation of a communication by a parent device, in accordance with some example embodiments described herein; and

FIG. 12 illustrates an example user interface illustrating information regarding a series of generated communications, in accordance with some example embodiments described herein.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention.

### Overview

The educational sphere is in the midst of a period of significant transition. State and local governments in many areas have chronically underfunded school systems or failed to plan for demographic changes that have placed significant burdens upon school budgeting. In the face of budget shortages, hiring practices are necessarily curtailed, which causes the need to finding ways to increase productivity without increasing staffing levels. At the same time, perceived decreases in compensation for teachers (and expected decreases in the reliability of future compensation) throughout the educational sector suggest that it will be more difficult to find employees willing to simply work extra hours to shoulder increases in per capita workload. As a result, increases in productivity are most readily achievably by increases in labor efficiency.

Given this dynamic, many problems with the traditional practices and procedures employed by schools and school systems are only now undergoing serious scrutiny for possible gains in both productivity and efficiency. The inventors have discovered one such area where increases in productivity and efficiency have only become possible because of growing adoption of new technology by the wider population: communication between teachers and administrators, the parents of the students those teachers and administrators oversee, or the students themselves (e.g., in scenarios where such students have reached the age of majority or where communication is directed towards the students themselves).

In particular, it is a routine a routine hassle for parents, teachers, and administrators to handle the need for continual parent authorization and/or monetary payment for student activities at the primary and secondary level. Currently, students themselves are often the vehicle by which authorization forms or payment requests are delivered to parents, for a variety of reasons, transmitting authorization requests in this fashion results in frequent failure to secure proper authorizations or payments and, as a result, forcing students to miss activities, forcing schools to shoulder increased liability and administration costs, and/or forcing others to increase their own monetary contributions to cover the failure to consistently secure payments from parents.

Similarly, communication between teachers, administrators, and parents is also important to address academic or behavioral issues of students, and for these issues, the process of relaying communications through the student/child personally may be undesirable and/or actively undermined.

In both scenarios, a more direct line of communication between teachers and administrators and parents is needed. However, in both scenarios, the paperwork burden of regular mail and the impracticality of phone communication render traditional methods of communication no better than the unreliable existing procedure. Many of these problems are overcome using example embodiments described in detail below, which rely upon previously unavailable technological improvements to address these pain points and minimize administrative hassle.

Specifically, the inventors discovered that advances in mobile connectivity and the emergent ubiquity of smartphone access provide new opportunities for process improvement with regard to the communication procedures utilized by educational systems. The improvements described herein have not heretofore been contemplated or, if contemplated, have not previously been possible due to the inadequate levels of adoption of new technology by a critical mass of parents.

As described in greater detail below, example embodiments provide a platform enabling educators (e.g., teachers and administrators), parents, and students to communicate electronically using the modes of communication they prefer. Parents (and in some embodiments, students) utilize the platform to develop action plans that provide preferred steps for delivery of notification messages in various alert categories (e.g., a general notification, a medical notification, a form notification requiring an authorization or payment, or the like). On the one hand, this enables the connection of various social media applications to the platform to facilitate easy communication on a number of vectors. On the other hand, it ensures accessibility of the platform, because while smartphone use is prevalent today, there are those who may not utilize mobile devices of this nature, and by allowing selection of personalized steps for parental notification, even those parents who do not employ smartphones can develop reliable and improved ways for direct contact with educators.

In accordance with example embodiments described herein, authorization requests can be delivered to parents seamlessly by a third party host system (and without the need for educators to themselves know the best way to communicate with any given parent). Moreover, responses to authorization requests can be delivered electronically and stored by the host system for recordkeeping purposes. Finally, by enabling fast, direct, and hassle-free communication between educators and parents and/or students, educators are freed from the administrative burdens accompanying traditional methods for securing authorizations, accounting, and notifying parents, enabling them to focus time and attention to other tasks, particularly their primary educational function. By increasing both the productivity and efficiency of educators, example embodiments described herein address a core problem facing primary and secondary educational institutions today.

### System Architecture and Example Apparatuses

Methods, apparatuses, and computer program products of the present invention may be embodied by any of a variety of devices. Example embodiments may include a plurality of networked devices, such as a host system, educator devices, parent devices, and/or other network entities, configured to operate in tandem. Example embodiments may include any of a variety of mobile terminals, such as a portable digital assistant (PDA), mobile telephone, smartphone, laptop computer, tablet computer, or any combination of the aforementioned devices. Similarly, the example embodiments may additionally or alternatively include any of a variety of fixed terminals, such as desktop computers, mainframe devices, kiosks or the like.

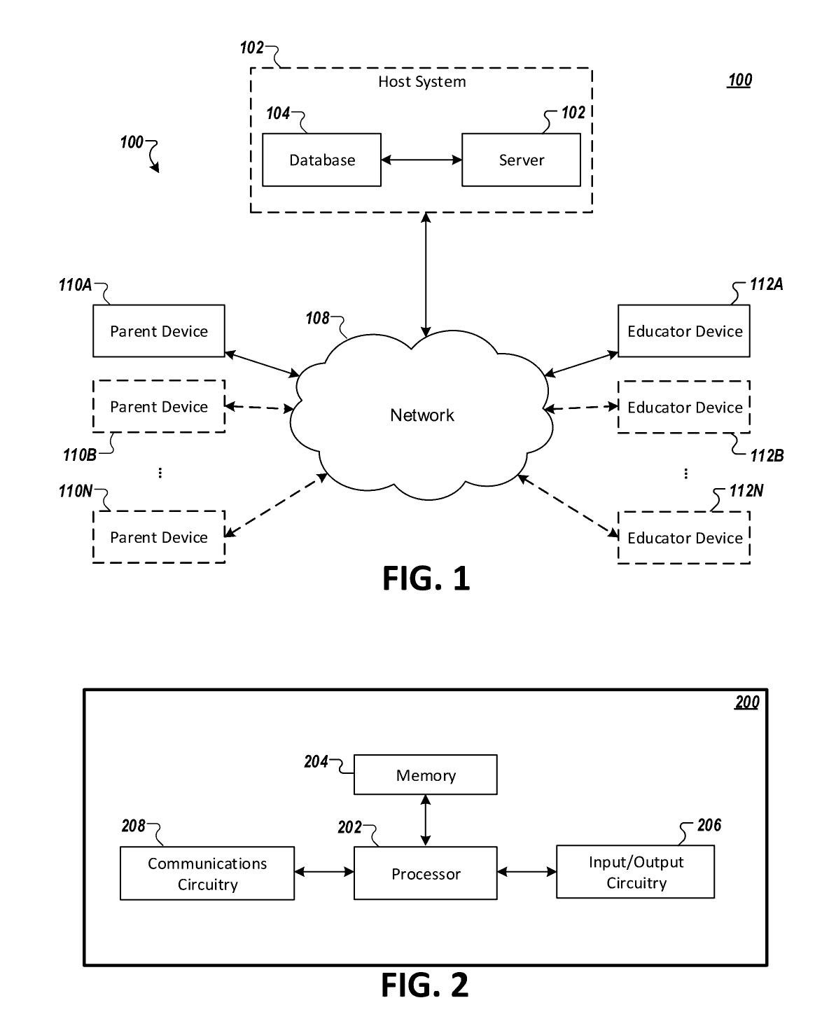

FIG. 1 discloses an example computing system 100 within which embodiments of the present invention may operate. As illustrated, a host system 102 may be connected to a network 108 (e.g., the Internet, or the like) that the host system 102 utilizes to communicate with a series of educator devices 110A through 110N. Similarly, parents may interact with the host system 102 via the network 108 using a series of parent devices 112A through 112N. The host system 102 may comprise a server 104 in communication with a database 106.

The server 104 may be embodied as a computer or computers as known in the art. The server 104 may provide for transmission of student-related data among various devices, including but not necessarily limited to the educator devices 110A-110N, the parent devices 112A-112N, and the database 106. For example, the server 104 may be operable to receive and process student-related data provided by the educator devices 110 and/or the parent devices 112. The server 104 may also facilitate transmission of notification messages based on triggering events identified by the host system 102, by the educator devices 110 and/or by the parent devices 112. The server 104 may facilitate the generation and circulation of various electronic communications based on the received triggering events.

The database 106 may be embodied as a data storage device such as a Network Attached Storage (NAS) device or devices, or as a separate database server or servers. The database 106 includes information accessed and stored by the server 104 to facilitate the operations of the host system 102. The database 106 may utilize a number of security and privacy measures to reduce the possibility that sensitive information regarding students, parents, or educators is leaked to unauthorized parties. In this regard, each educator device 110 and parent device 112 may require multi-factor authentication (e.g., a password provided via the device and a biometric reading provided via the device, a password provided via the device and a device-specific token provided by the server 104 to the educator device 110 or parent device 112 upon installation of the relevant applications, or other combinations of security measures). Moreover, transmission of data regarding particular students, parents, or educators may be encrypted when possible.

Moreover, the database 106 may include account credentials for educators and parents that enable educators and parents to log into and utilize a platform provided by the host system 102 via educator devices 110A-110N and parent devices 112A-112N, respectively. To accompany the account credentials enabling specific identification of particular users who may interact with the host system 102, the database 106 may further store additional information regarding forms, notifications, action plans, historical information, and student-related data that is accessible to or received from particular devices associated with the stored account credentials.

For instance, the database 106 may store forms designed for transmission between educators and parents. These forms may be generic in nature and/or may be tailored to the needs and/or desires of particular educators, particular schools, particular school systems, particular local, state, provincial, or federal governments, or the like. The specific tailoring of proprietary forms may be based on the applicable traditions, preferences, rules, regulations, or laws governing the authorizations and/or disclosures required to facilitate the daily progression of school functions for a particular set of students or all students in general.

The database 106 may also store a set of notification templates, which also may be generic or tailored designs. These notification templates may be designed for transmission to parent devices upon the occurrence of a predefined triggering event, but in some embodiments may also be designed for transmission to educator devices, to the host system 102, or even to third party devices (e.g., student devices, vendor devices, or local, state, or federal government computing environments with which the host system 102 is configured to communicate). Any particular notification template may identify a triggering event, a recipient list, and a set of included data.

In addition to forms and notification templates, the database 106 also stores action plans that are developed through the interaction of parents with the host system 102 (e.g., via parent devices 112A-112N or the like). Each action plan includes preferences regarding a parent's desired contact methods for receiving communications from the host system 102. For instance, an action plan for a first parent may specify that if a particular triggering event occurs, then the first parent will receive a notification via an app on the parent's mobile device. Alternatively, an action plan for another parent may require transmission of the notification via email, text, a plurality of social media networks, and one or more conventional communication channels (e.g., telephone, mail, or the like).

However, while most action plans are dynamic and definable by parents, some action plans may be static due to particular arrangements made between the entity operating the host system 102 and a partnering educational institution (e.g., school, school system, or the like). For instance, certain types of forms and/or notifications may be hard-coded for delivery via specific channels (e.g., a school may mandate that notifications regarding schedule changes due to inclement weather, medical emergencies, or the like are automatically delivered via phone, email, and text message).

In addition, some action plans may comprise hybrids of the static and dynamic action plans described above. In this regard, hybrid action plans may have some predefined fixed aspects (e.g., mandated notification delivery via phone) and others that may be configurable by a parent via interaction with the host system 102 (e.g., additional modes of notification delivery for particular triggering events).

In addition to forms, notifications, and action plans, the database 106 may also store historical information, such as transmission records that identify prior transmissions between one or more of the host system 102, educator devices 110A-110N and parent devices 112A-112N, and that further identify when those transmissions were sent, the contents of those transmissions, and whether there are unresolved items relating to those transmissions (e.g., whether additional authorizations, signatures, or payments are required from an educator or parent associated with one or more of the educator devices 110A-110N or parent devices 112A-112N.

Finally, the database 106 may store student-related data, which may be retrieved from one or more databases operated by a school (or school system) partnering with the entity that operates the host system 102. Additionally or alternatively, the student-related data may in some embodiments be gathered by the host system 102 itself from various other sources external to a school system, such as educator devices 110A-110N, parent devices 112A-112N, federal, state, or local government databases, proprietary data hosting services, contracting vendors, social media platforms, or from student devices (not shown in FIG. 1) that can interact with the host system 102.

The student-related data stored by the database 106 of the host system 102 may include data regarding the various students attending schools partnering with the entity that operates the host system 102, and this data may be segregated within database 106 into sets of data associated with each partnering school or school system or even into groups of smaller size and granularity, such as school type (e.g., elementary school, middle school, high school, etc.), class year, or the like. For any given student, the student-related information may include that student's biographical information (including, in some embodiments, biographical information regarding the student's parents and/or siblings), emergency contact information, medical information, performance information, activity participation information, payment information, historical data, and, in some embodiments, this student-related information for a particular student may include analytic results, academic performance, reports, financial data, and/or the like generated and/or otherwise related to the other types of student-related information.

The educator devices 110A-110N may be embodied by any computing devices known in the art. Although referred to herein as “educator devices,” it should be understood that these devices 110A-110N may in some embodiments be employed by a broader user base. For instance, when the system is employed in a caretaker environment (e.g., by daycare providers, elder care providers, or the like), devices 110A-110N may be operated by caretakers rather than “educators.” Still further, the system may be utilized in other environments where communication between parties is necessary, but still largely reliant upon traditional modes of communication (e.g., extracurricular student organizations, athletic organizations, homeowner associations, theme parks, or even correctional facilities (such as minimum security facilities where restrictions may be somewhat relaxed but the prison administration may still have to contact responsible parties outside the prison in order to make decisions)). Nevertheless, despite the fact that these systems need not be confined to education settings, the terms “educator” and “educator device” are used herein for the sake of simplicity. The educator devices 110A-110N may transmit messages to the server 104 in various forms and via various methods. For example, the educator devices 110A-110N may include laptop computers, smartphones, netbooks, tablet computers, wearable devices, or the like. The information may be provided through various sources on these consumer devices.

In some embodiments, an educator device 110 may execute an “app” to interact with the host system 102, other educator devices, and/or parent devices 112A-112N. Such apps are typically designed to execute on mobile devices, such as tablets or smartphones. For example, an app may be provided that executes on mobile device operating systems such as Apple Inc.'s iOS®, Google Inc.'s Android®, or Microsoft Inc.'s Windows 8®. These platforms typically provide frameworks that allow apps to communicate with one another and with particular hardware and software components of mobile devices. For example, the mobile operating systems named above provide frameworks for interacting with location services circuitry, wired and wireless network interfaces, user contacts, and other applications in a manner that allows for improved interactions between apps while also preserving the privacy and security of individual users. Communication with hardware and software modules executing outside of the app is typically provided via application programming interfaces (APIs) provided by the mobile device operating system.

In this regard, if the mobile device includes any social networking capabilities, the educator may enable the app to utilize the educator's social network as a notification mechanism. It should be appreciated that the use of mobile technology and associated app frameworks may provide for particularly unique and beneficial uses of the host system through leveraging the functionality offered by the various mobile operating systems.

Additionally or alternatively, the educator device 110 may interact with the host system 102 or parent device 112 via a web browser. As yet another example, the educator device 110 may include various hardware or firmware designed to interface with the host system 102 or parent device 112 (e.g., where the educator device 110 is a purpose-built device offered for the primary purpose of communicating with the host system 102).

The parent devices 112A-112N may be any computing devices known in the art and operated by a parent (or designated responsible adult) of a student enrolled at a school (or within a school district) that has partnered with the entity operating the host system 102. Although referred to herein as “parent devices,” it should be understood that these devices 112A-112N may in some embodiments be used by a broader user base. For instance, when the system is employed in a caretaker environment (e.g., by daycare providers, elder care providers, or the like), devices 112A-112N may be operated by legal guardians rather than “parents.” Similarly, in embodiments in which students have reached the age of majority, the students themselves may operate devices 112A-112N. In various embodiments, the devices 112A-112N are those used by intended recipients of communications transmitted via example embodiments of the platform contemplated herein. Nevertheless, despite the fact that these systems need not be confined to education settings where students have not reached the age of majority, the terms “parent” and “parent device” are used herein for the sake of simplicity. Each of the parent devices 112A-112N may include a computing device accessing a web site designed to provide merchant access (e.g., a smartphone, PDA, or desktop computer configured to access a web page via a browser using a set of merchant account credentials). Each of the parent devices 112A-112N may execute an application to interact with the host system 102 and educator devices 110A-110N. In this regard, the parent devices 112A-112N may provide information to the host system 102 in various forms and via various methods. Similarly, the parent devices 112A-112N may receive transmissions from the host system 102 and/or an educator device 110A-110N.

Like the educator devices 110A-110N, the parent devices 112A-112N may be embodied by any computing devices known in the art. The parent devices 112A-112N may transmit messages to the server 104 in various forms and via various methods. For example, the parent devices 112A-112N may include laptop computers, smartphones, netbooks, tablet computers, wearable devices, or the like. The information may be provided through various sources on these consumer devices.

Like the educator devices 110A-110N, a parent device 112 may execute an “app” to interact with the host system 102, educator devices 110A-110N, and/or with other parent devices 112A-112N. In this regard, if the parent device 112 includes any social networking capabilities, the parent may enable the app to utilize one or more the parent's social networking platforms as a notification mechanism.

Additionally or alternatively, the parent devices 112A-112N may interact with the host system 102 or educator device 110A-110N via a web browser. As yet another example, the parent devices 112A-112N may include various hardware or firmware designed to interface with the host system 102 or educator device 110A-110N (e.g., where a parent devices 112 is a purpose-built device offered for the primary purpose of communicating with the host system 102).

### EXAMPLE IMPLEMENTING APPARATUSES

Having provided a high level description of the various devices employed by the example embodiments contemplated herein, a low-level description of the various components comprising each of these devices will now be provided.

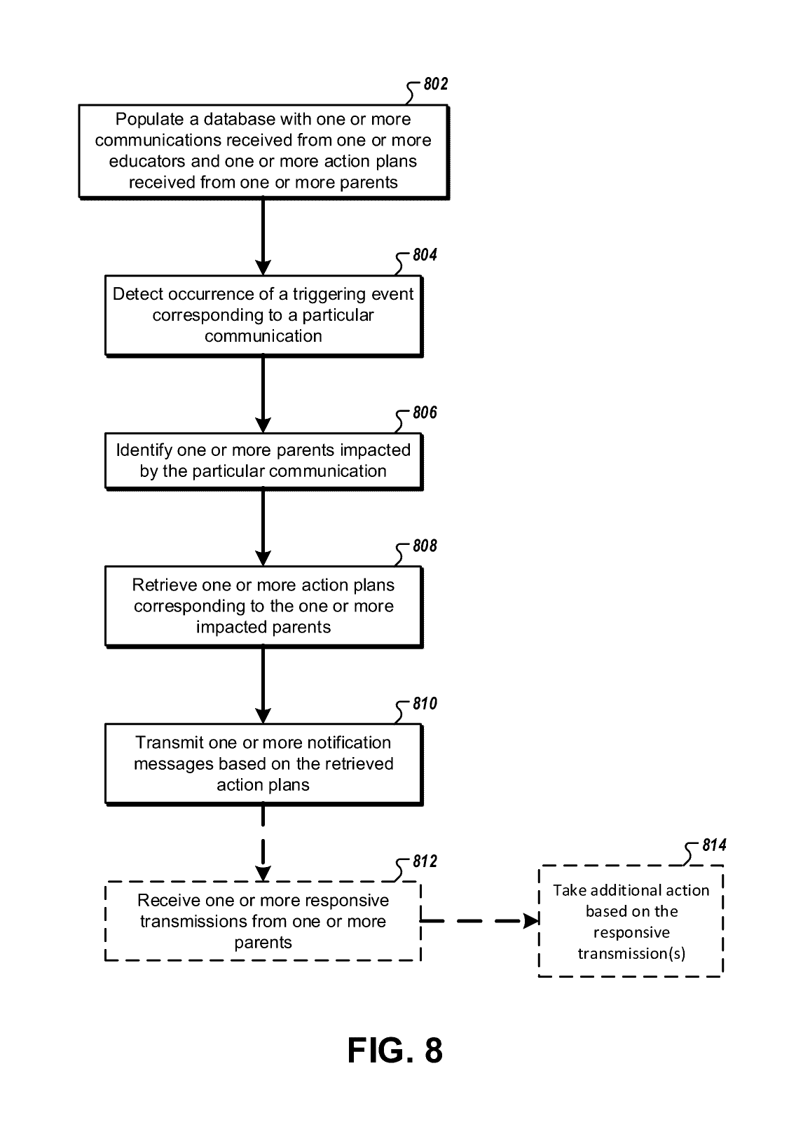

Turning first to FIG. 2, the server device(s) 104 may be embodied by one or more computing systems, such as apparatus 200 shown in FIG. 2. As illustrated in FIG. 2, the apparatus 200 may include a processor 202, a memory 204, input/output circuitry 206, and communications circuitry 208. The apparatus 200 may be configured to execute the operations described above in connection with FIG. 1 and below in connection with FIGS. 8-10. Although these components 202-208 are described with some functional descriptors, it should be understood that the particular implementations necessarily include the use of particular hardware. It should also be understood that certain of these components 202-208 may include similar or common hardware. For example, two sets of circuitry may both leverage use of the same processor, network interface, storage medium, or the like to perform their associated functions, such that duplicate hardware is not required for each set of circuitry (although embodiments using duplicated hardware may also be used). The use of the term “circuitry” as used herein with respect to components of the apparatus therefore includes particular hardware configured to perform the functions associated with the particular circuitry described herein.

Of course, while the term “circuitry” should be understood broadly to include hardware, in some embodiments, circuitry may also include software for configuring the hardware. For example, in some embodiments, “circuitry” may include processing circuitry, storage media, network interfaces, input/output devices, and the like. In some embodiments, other elements of the apparatus 200 may provide or supplement the functionality of particular circuitry. For example, the processor 202 may provide processing functionality, the memory 204 may provide storage functionality, input/output circuitry 206 may provide user interface functionality, communications circuitry 208 may provide network interface functionality, and the like.

In some embodiments, the processor 202 (and/or co-processor or any other processing circuitry assisting or otherwise associated with the processor) may be in communication with the memory 204 via a bus for passing information among components of the apparatus. The memory 204 may be non-transitory and may include, for example, one or more volatile and/or non-volatile memories. In other words, for example, the memory may be an electronic storage device (e.g., a computer readable storage medium). The memory 204 may be configured to store information, data, content, applications, instructions, or the like, for enabling the apparatus to carry out various functions in accordance with example embodiments contemplated herein.

The processor 202 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor. Alternatively or additionally, the processor may be configured to execute hard-coded functionality. As such, whether configured by hardware or software methods, or by a combination of hardware with software, the processor may represent an entity (e.g., physically embodied in circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display that may include a web user interface, a mobile application, a client device, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s). These signals may be transmitted by the apparatus 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

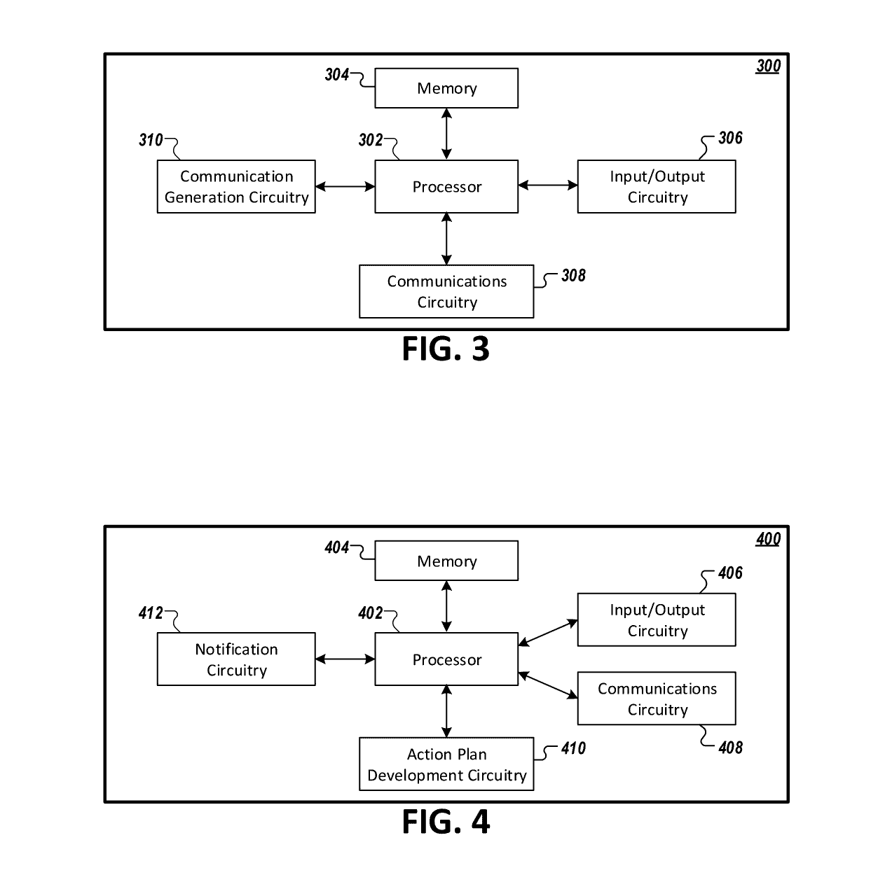

Turning next to FIG. 3, an example hardware configuration of educator devices 110A-110N is provided. These devices may be embodied by one or more computing systems, such as apparatus 400 shown in FIG. 3. As illustrated in FIG. 3, the apparatus 300 may include a processor 302, a memory 304, input/output circuitry 306, communications circuitry 308, and communications generation circuitry 310.

As it relates to operations described in the present invention, the functioning of the processor 302, the memory 304, the input/output circuitry 306, and the communications circuitry 308 may be similar to the similarly named components described above with respect to FIG. 2, and for the sake of brevity, additional description of the mechanics of those components is omitted. Nevertheless, these device elements, operating together, provide the apparatus 300 with the functionality necessary for the educator devices 110A-110N to communicate with the host system 102, one or more other educator devices 110A-110N, and/or one or more parents operating one or more parent devices 112A-112N.

In addition, the apparatus 300 also comprises communications generation circuitry 310, which includes hardware components designed to generate communications designed by an educator and for transmission to the host system 102 in order to prompt and/or schedule circulation of notification messages to parents associated with the students to whom the various generated communications relate. Communications generation circuitry 310 may utilize memory 304, input/output circuitry 306, or any other hardware component included in the apparatus 300 to generate these communications. Communications generation circuitry 310 may further utilize communications circuitry 308 to transmit the generated communications to external sources (e.g., host system 102, directly to one or more of parent devices 112A-112N, or to other devices such as student devices (not shown in FIG. 1)).

Communications generation circuitry 310 may utilize processing circuitry, such as the processor 302, to facilitate performance of the above operations, and may utilize memory 304 to store the generated communications prior to (or, conceivably, after) transmission to the host system 102. It should be appreciated that, in some embodiments, communications generation circuitry 310 may include a separate processor, specially configured field programmable gate array (FPGA), or application specific interface circuit (ASIC) to perform the above-described functions. Communications generation circuitry 310 is therefore implemented using hardware components of the apparatus configured by either hardware or software for implementing these planned functions.

It should be understood that while communications generation circuitry 310 is described as an element of an apparatus 300, in some embodiments, one or more external systems (such as a host system 102) may also be leveraged to provide at least some of the functionality of this circuitry.

Finally, the parent device(s) 112 may be embodied by one or more computing systems, such as apparatus 400 shown in FIG. 4. As illustrated in FIG. 4, the apparatus 400 may include a processor 402, a memory 404, input/output circuitry 406, communications circuitry 408, action plan development circuitry 410, and notification circuitry 412. As it relates to operations described in the present invention, the functioning of the processor 402, the memory 404, input/output circuitry 406, and communication circuitry 408 may be similar to the similarly named components described above with respect to FIGS. 2 and 3 above, and for the sake of brevity, additional description of the mechanics of these components is omitted. Nevertheless, these device elements, operating together, provide the apparatus 300 with the functionality necessary to facilitate the communication of data (e.g., electronic marketing information, business analytic data, or the like) between a parent utilizing the parent device(2) 112, a host system 102, and one or more educator devices 110A-110N.

Action plan development circuitry 410 includes hardware configured to facilitate the development, by apparatus 400, of action plans for the parent associated with the parent device. Action plan development circuitry 410 may utilize input/output circuitry 406, or any other hardware component included in the apparatus 400 to facilitate the development of action plans on behalf of a parent. Action plan generation circuitry 410 may further utilize communications circuitry 408 to transmit the generated action plans to external sources (e.g., host system 102, directly to one or more of the educator devices 110A-110N, or to other devices (not shown in FIG. 1)).

It should be appreciated that, in some embodiments, action plan development circuitry 410 may include a separate processor, specially configured FPGA, or ASIC to perform these functions. Action plan development circuitry 410 is therefore implemented using hardware components of the apparatus configured by either hardware or software for implementing these planned functions.

Notification circuitry 412 includes hardware configured to facilitate the development, by apparatus 400, of action plans for the parent associated with the parent device. Notification circuitry 410 may utilize input/output circuitry 406, or any other hardware component included in the apparatus 400 to facilitate the presentation of notifications to a parent. Notification circuitry 410 may further utilize communications circuitry 408 to receive the notifications from external sources (e.g., host system 102).

It should be appreciated that, in some embodiments, notification circuitry 410 may include a separate processor, specially configured FPGA, or ASIC to perform these functions. Notification circuitry 410 is therefore implemented using hardware components of the apparatus configured by either hardware or software for implementing these planned functions.

It should be understood that while action plan development circuitry 410 and notification circuitry 412 are described as element of apparatus 400, in some embodiments, one or more external systems (such as a host system 102) may also be leveraged to provide at least some of the functionality of this circuitry.

As described above and as will be appreciated based on this disclosure, example embodiments may be configured as systems, methods, mobile devices, backend network devices, and/or the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

It should be appreciated, with respect to certain embodiments of the apparatuses described in FIGS. 2-4, computer program instructions and/or other type of code may be loaded onto a computer, processor or other programmable apparatus's circuitry to produce a machine, such that the computer, processor other programmable circuitry that execute the code on the machine create the means for implementing various functions described herein.

Having described specific components of an example server device (e.g., apparatus 200) that may embody the host system 102, an example educator device 110 (e.g., apparatus 300), and an example parent device 112 (e.g., apparatus 400), example embodiments facilitating Internet-based communication between educators and parents are described below in connection with corresponding user interface designs. Subsequently, flowcharts are provided which describe some example operations performed variously by the host system 102, educator devices 110A-110N and parent devices 112A-112N.

### User Interfaces

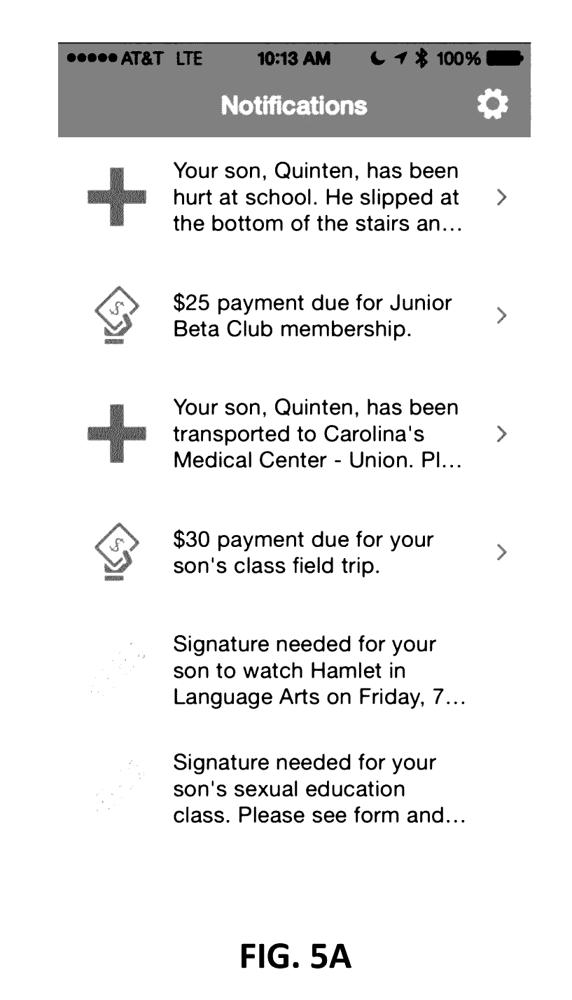

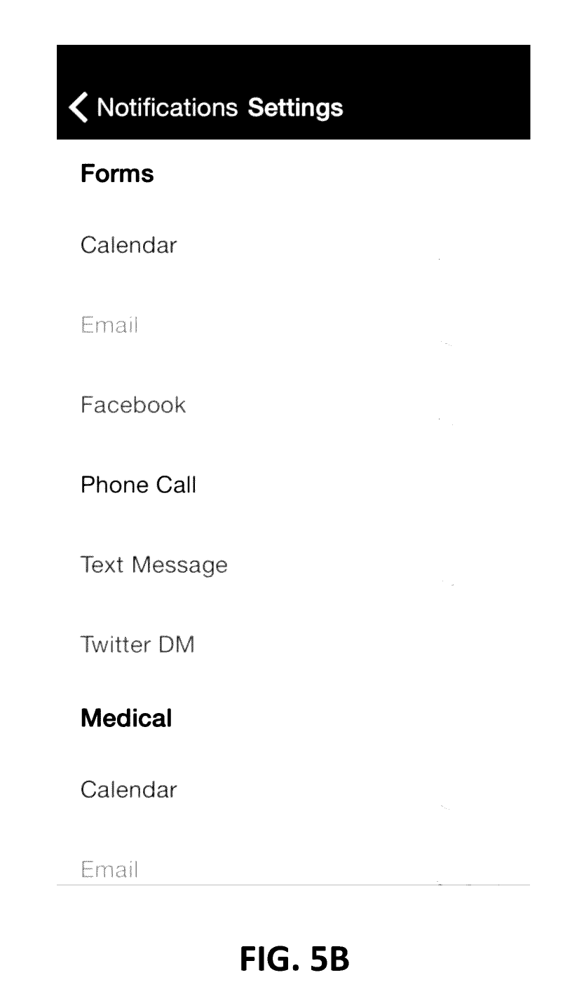

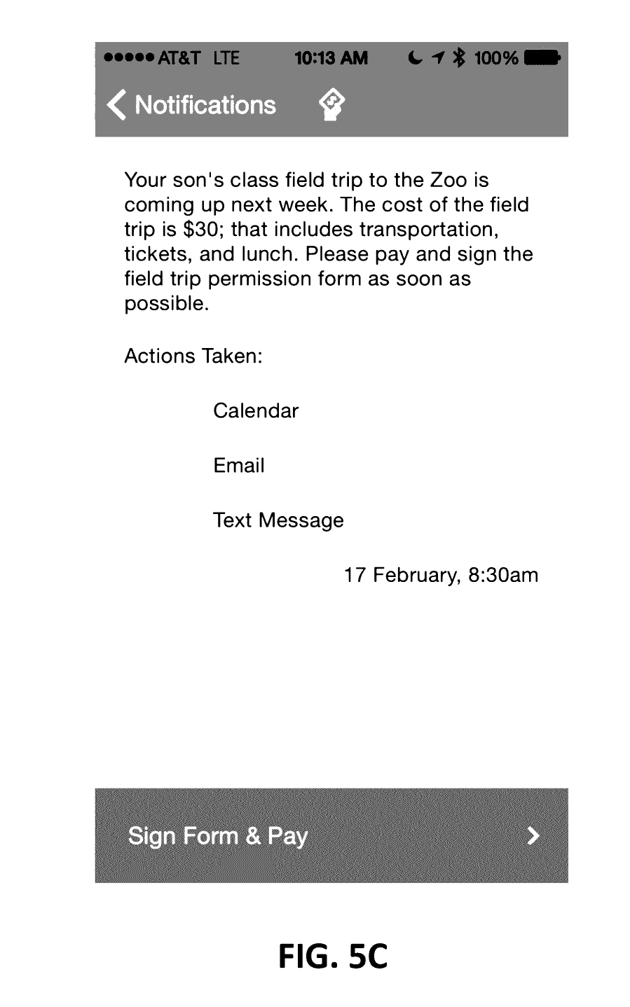

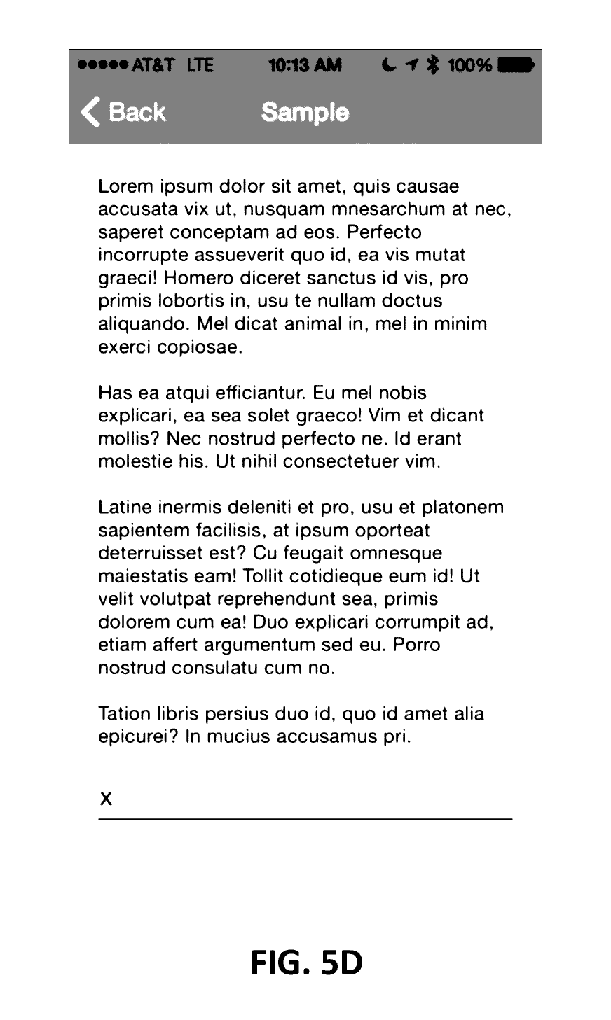

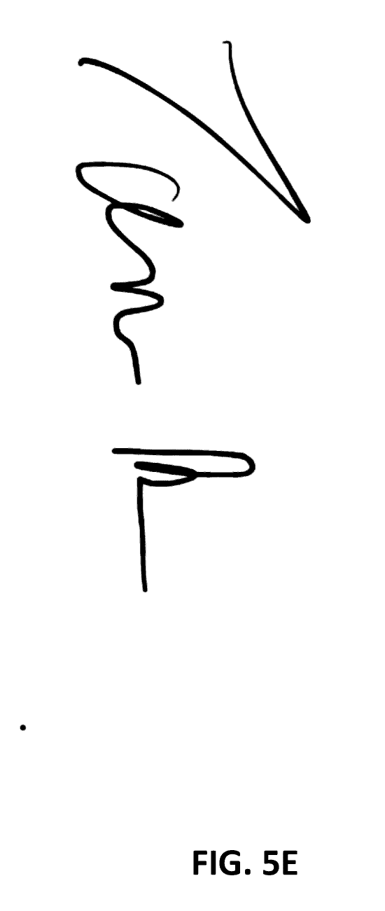

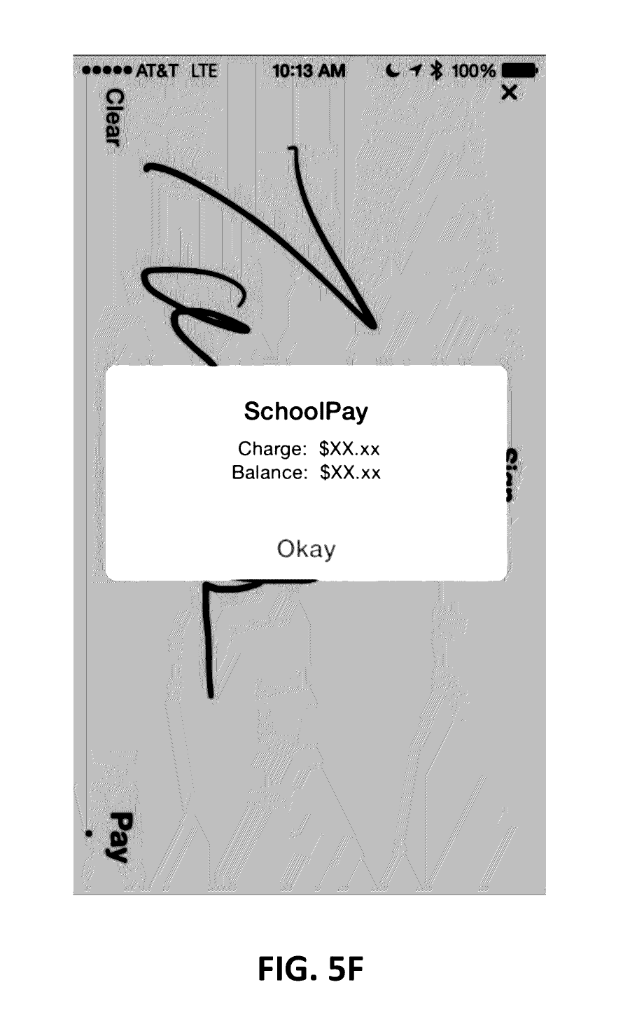

Turning now to FIGS. 5A-5E, 6, and 7A-7E, some user interfaces will now be described that illustrate various displays provided by a parent device, as contemplated in some example embodiments contemplated herein.

Turning first to FIGS. 5A-5F, a series of example user interfaces provided by a parent's mobile device, in accordance with some example embodiments described herein. As will be discussed below, a parent may utilize multiple devices, such as a desktop computer in a home or office setting, and a smartphone, tablet, or other small-scale mobile device when traveling or otherwise not in the vicinity of a desktop computer. FIG. 5A illustrates a series of push notifications prompted by an app installed on a parent's mobile device. As described in greater detail below, the host system 102 is configured to transmit one or more notification messages based on a parent's action plan for a particular alert category, and one such notification message may comprise a push notification via the parent's mobile device.

FIG. 5B illustrates a menu enabling the parent to edit the action plans associated with different types of alert categories. To do so, the parent may select a toggle button associated with each available type of notification under the different alert category headings (e.g., “Forms”, “Medical”, or the like).

FIGS. 5C through 5F illustrate a sequential progression of interfaces utilizing which a parent may receive a form notification, review its contents, sign the form notification, authorize a corresponding payment, and cause transmission of a responsive message to the host system 102.

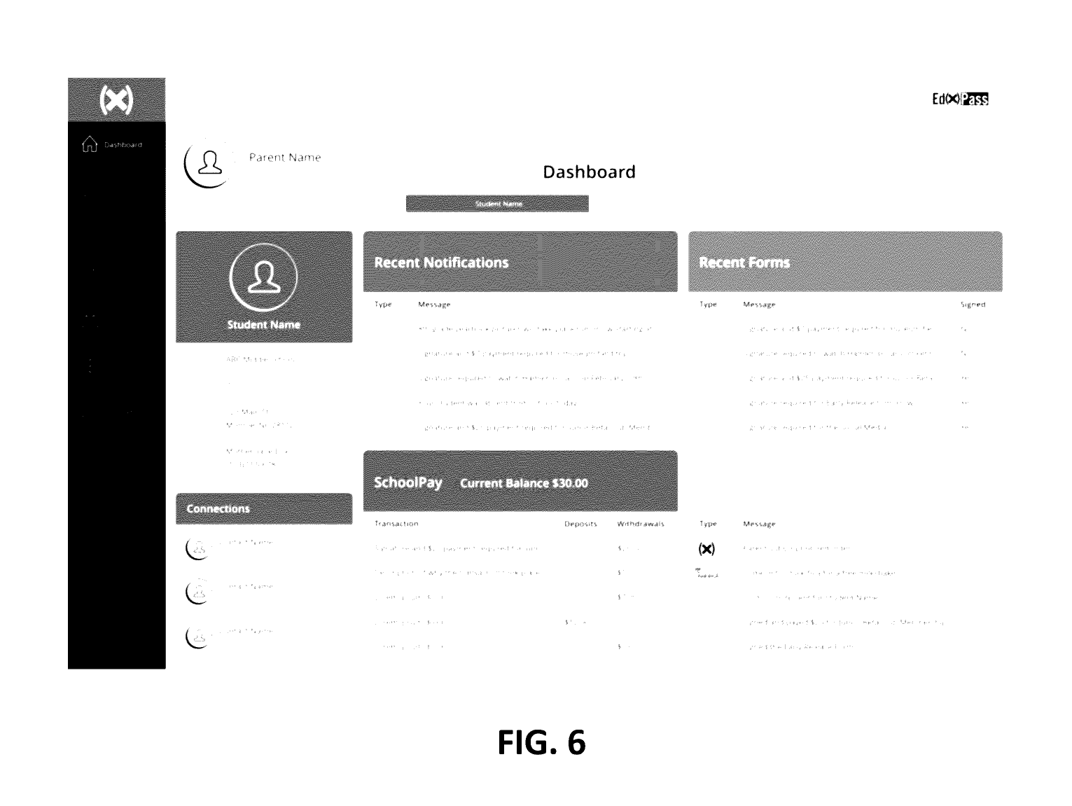

Turning next to FIG. 6, an example dashboard user interface provided that may, for instance, be a landing page for a parent accessing the platform via a desktop computer or other device having a sufficiently large viewable display. As illustrated in FIG. 6, the parent may be presented with a series of display areas providing relevant information. The “Student” display area illustrates biographical details of the student associated with that parent (e.g., the parent's child). A “Connections” display area may list a series of educators and/or other parents with whom the parent may communicate using in-app messaging functionality. The “Recent Notifications”, “Recent Forms”, and “Recent Activity” display areas provide a quick synopsis of the various communications received from educators regarding the student associated with the parent. Finally, the “SchoolPay” display area provides a historical record of past payment transactions via the platform.

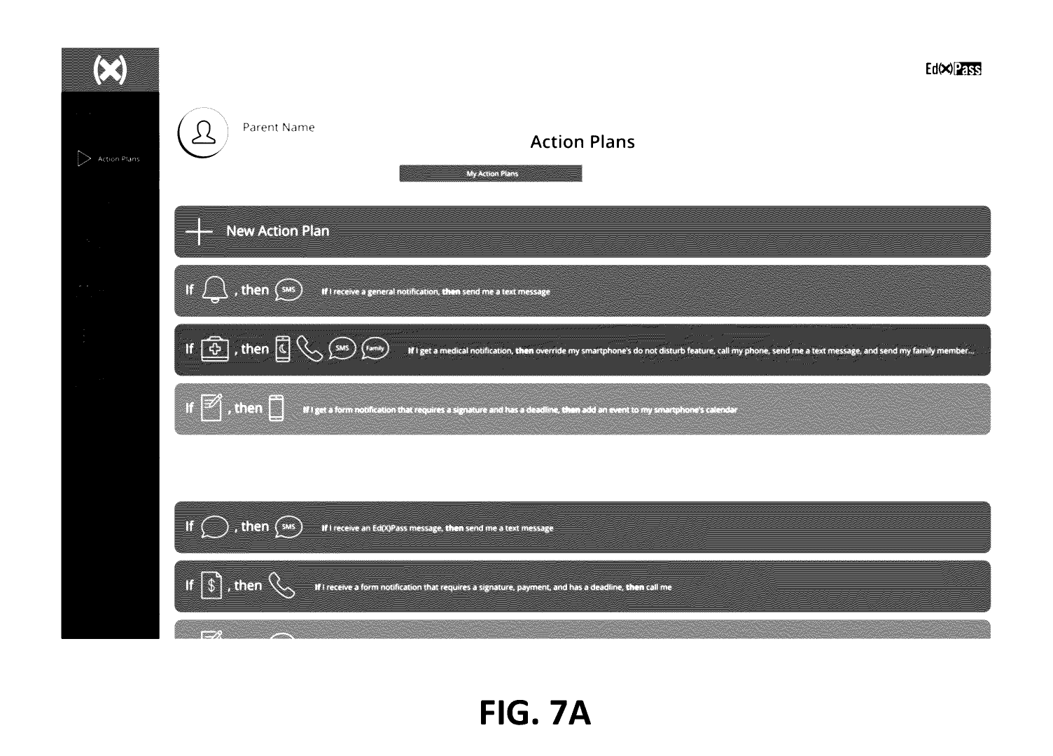

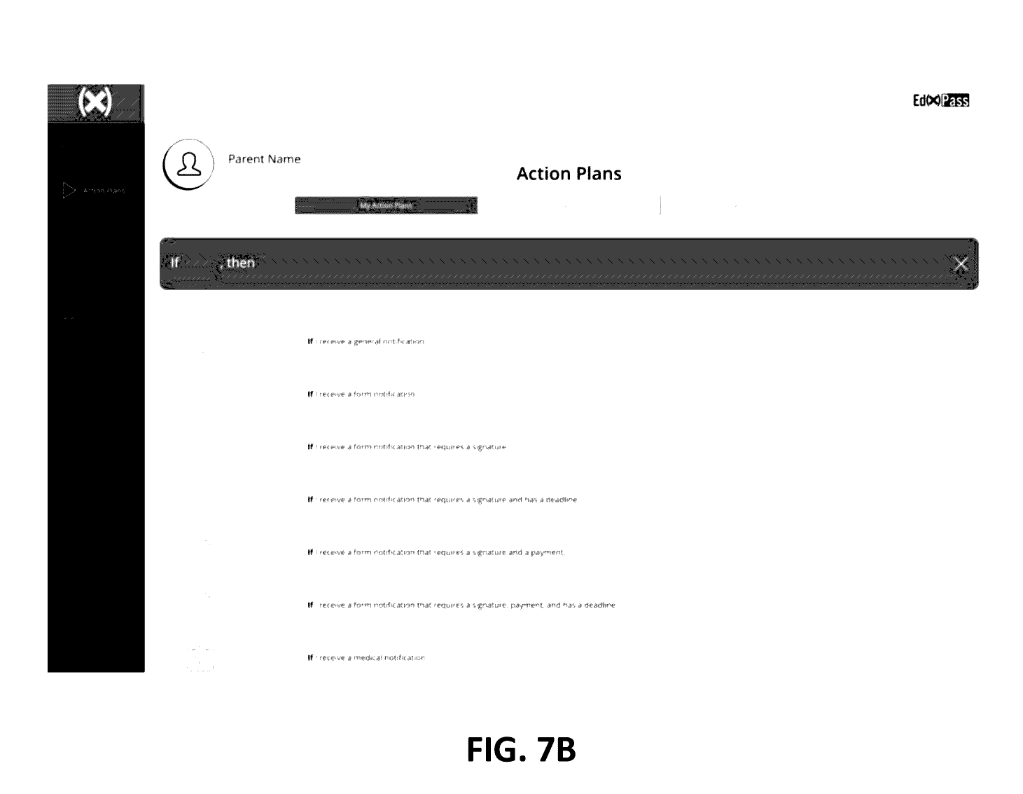

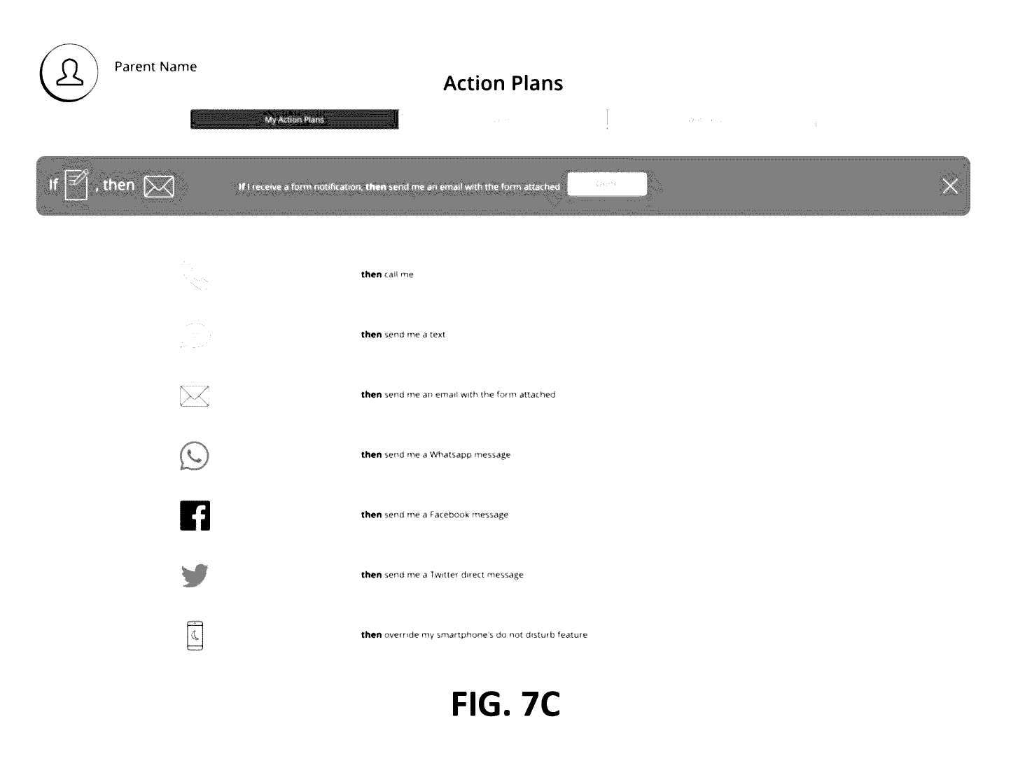

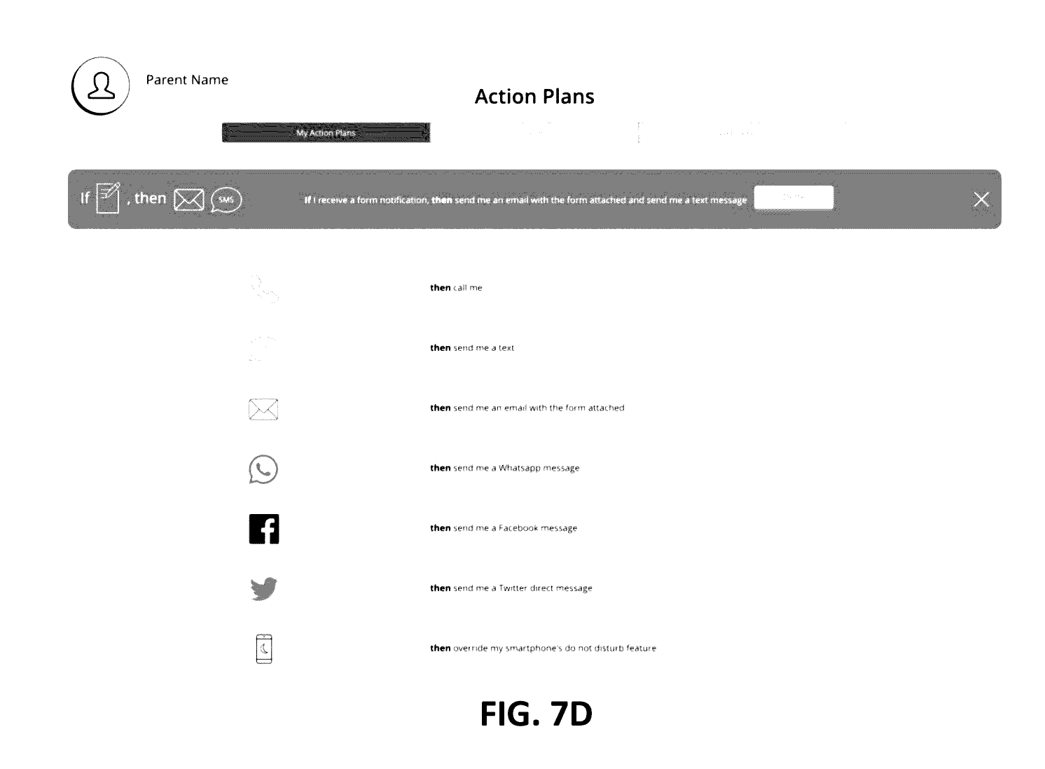

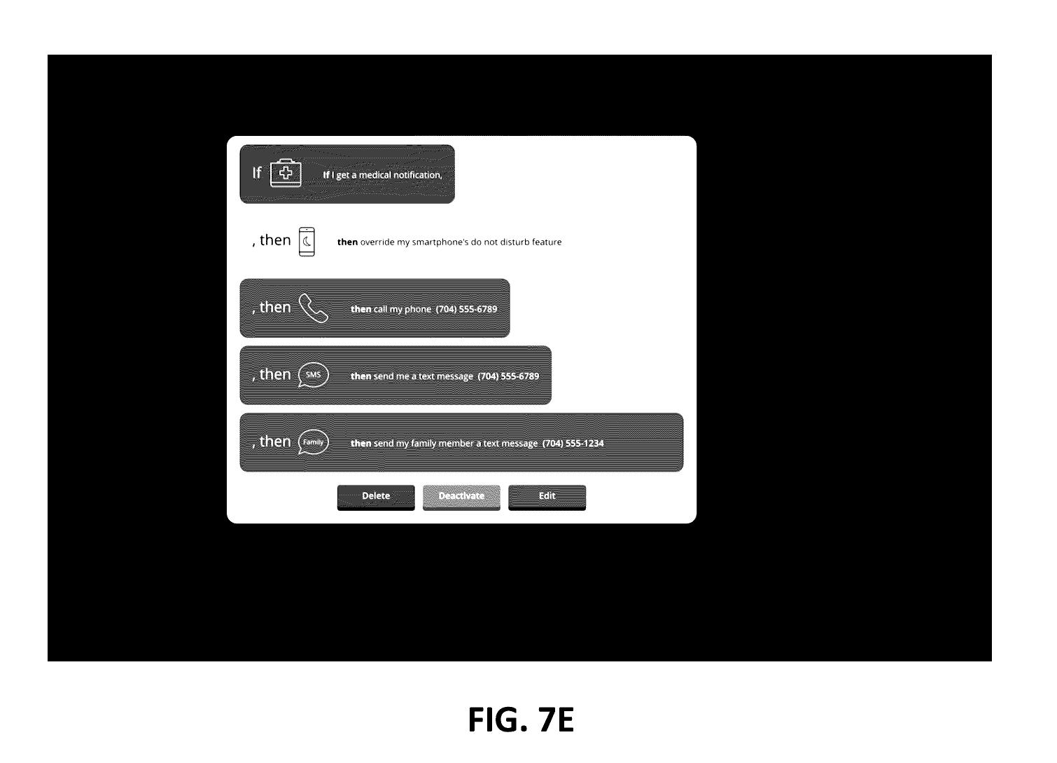

Turing to FIGS. 7A-7E a series of illustrations of user interfaces presented by a parent device to facilitate the generation, by a parent device, of one or more action plans. While an action plan may be easily edited via a parent's mobile device, as noted above in connection with FIG. 5B, devices providing a larger display footprint may be presented with a more intuitive graphical interface enabling generation and/or editing of a series of action plans. In this regard, FIG. 7A illustrates a landing page associated with the action plan generation interface. The landing page provides the ability to create a new action plan, and also lists, in descending rows, a series of action plans previously generated and describes the corresponding actions for each action plan using intuitive icons to represent each action within the action plan.

Upon selection of the “New Action Plan” icon, the parent device may present an interface such as that shown in FIG. 7B, which enables the selection of an alert category corresponding to the new action plan being generated. Once an alert category has been selected, then the parent device may present the interface similar to that shown in FIG. 7C, enabling the parent to identify a series of notification methods by which the parent requests notification when a triggering event associated with a communication within the identified alert category occurs. As shown in FIG. 7D, multiple notification methods may be selected, and each selected notification method is illustrated by a corresponding icon. Finally, as shown in FIG. 7E, an action plan editing interface may also be provided. This interface may enable deletion, deactivation (or reactivation) or editing of a previously generated action plan. Moreover, some notification methods may require more detailed information than the selection of a corresponding icon, and that information may be entered in an action plan editing interface of this nature (FIG. 7E, for instance, displays an action plan for which a user has entered more detailed information regarding phone numbers to call, text, and for contacting a relative in case a medical notification message is transmitted).

Having provided an overview of various interfaces using which parent devices may facilitate use of embodiments of the platform contemplated herein, specific operations performed by various parties contemplated herein will now be discussed in turn.

### Operations Performed by a Server Device

Turning now to FIG. 8, a flowchart is illustrated that contains a series of operations performed by a host system 102 for facilitating Internet-based communication between educators and parents who are located remotely from each other. The operations illustrated in FIG. 8 may, for example, be performed by, with the assistance of, and/or under the control of an apparatus 200 embodying a server device 104, and more particularly through the use of one or more of processor 202, memory 204, input/output circuitry 206, and communications circuitry 208.

In operation 802 the apparatus 200 includes means, such as processor 202, memory 204, input/output circuitry 206, communications circuitry 208, or the like, for populating a database with one or more communications associated with one or more students and categorized within one or more alert categories, and one or more action plans associated with one or more parents and at least one of the one or more alert categories. In some embodiments, each of the one or more communications comprises a notification or a form. Similarly, in some embodiments, the database further stores correlations of each of the one or more students to at least one of the one or more parents, in order to facilitate the discovery of parents associated with particular students or vice versa.

In some embodiments, populating the database comprises the receipt of various data elements from the educator and/or parent devices. In this regard, operation 802 may include means, such as processor 202, memory 204, input/output circuitry 206, communications circuitry 208, or the like, for receiving the one or more communications from one or more educator devices, identifying triggering events corresponding to the received one or more communications, and storing, in the database, the received one or more communications, one or more indications of the one or more students associated with the one or more communications, one or more indications of the alert categories within which the one or more communications are categorized, and one or more indications of the identified triggering events corresponding to the received one or more communications.

Additionally or alternatively, operation 802 may include means, such as processor 202, memory 204, input/output circuitry 206, communications circuitry 208, or the like, for receiving the one or more action plans from one or more parent devices, storing the one or more action plans in the database in association with the one or more parents and the at least one of the one or more alert categories, receiving the correlations of the one or more students to at least one of the one or more parents from one or more educator devices, and storing the received correlations in the database.

Moreover, the means for receiving an action plan may further include means, such as processor 202, communications circuitry 208, or the like, for causing a parent device to display an action plan generation interface, wherein the action plan generation interface is configured to prompt the parent device to select one or more notification methods for a chosen alert category, and receiving, from the parent device, selection of a set of notification methods for the chosen alert category, wherein the set of notification methods for the chosen alert category comprises the action plan.

In operation 804 the apparatus 200 includes means, such as processor 202, memory 204, or the like, for detecting, by a processor, occurrence of a triggering event corresponding to a particular communication in the database. In some embodiment, a triggering event comprises at least one of occurrence of a user-defined date, occurrence of a date that is a predefined number of days after the user-defined date, or occurrence of a date a predefined number of days before a student activity requiring parent authorization. More specifically, a triggering event for a particular notification may comprise a particular date entered by the educator creating the notification message. A subsequent triggering event for the particular notification may comprise a date occurring a predefined number of days after an original triggering event (e.g., one week later). It should be understood that subsequent triggering events of this nature, which may prompt reminder messages, can also occur a predefined number of days after another subsequent triggering event. Additionally or alternatively, a triggering event for a particular notification may comprise a date occurring a predefined number of days before a corresponding student activity requiring parent authorization (e.g., a field trip). While these triggering events may be identified by date, it is also contemplated that more granular timing may be selected as well, and that triggering events can occur at particular times of day on a particular day

Accordingly, in some embodiments, detecting the occurrence of the triggering event corresponding to the particular communication includes retrieving a current date, identifying whether the current date comprises a triggering event corresponding to any communication stored in the database, and determining that the current date comprises a triggering event corresponding to the particular communication.

It should be understood that non-date-based events may also comprise triggering events. For instance, if database 104 is updated with new information regarding a particular student, that update may be a triggering event for transmitting a notification to a corresponding parent device 112 to indicate the information that was updated. Moreover, different database updates may fall into different alert categories. For instance, an update regarding a student's performance on a test may fall within an alert category that triggers a general notification, for which a corresponding action plan may indicate a first set of notification methods. However, an update regarding that student's medical records may fall within a different alert category that triggers a medical notification, for which the corresponding action plan may be different (and, for instance, may be designed to convey more notification messages and/or more invasive notification messages).

In operation 806 the apparatus 200 includes means, such as processor 202, or the like, for identifying one or more parents impacted by the particular communication. In some embodiments, identifying the one or more parents impacted by the particular communication includes retrieving the one or more students associated with the particular communication, and identifying the one or more parents impacted by the particular communication using the correlations of the one or more students to at least one of the one or more parents.

In operation 808 the apparatus 200 includes means, such as processor 202, memory 204, input/output circuitry 206, communications circuitry 208, or the like, for retrieving one or more action plans based on the one or more parents impacted by the particular communication and an alert category into which the particular communication is categorized.

In operation 810 the apparatus 200 includes means, such as processor 202, communications circuitry 208, or the like, for causing, by the processor, transmission of one or more notification messages based on the retrieved one or more action plans. In some embodiments, causing transmission of the one or more notification messages includes, causing transmission of notification messages for each of the retrieved one or more action plans. In turn, causing notification for each action plan may include identifying, from the action plan, a set of notification methods and, for each notification method of the set of notification methods, identifying, from the action plan, one or more target recipients for the notification method, generating notification messages for the one or more target recipients based on the particular communication, and transmitting the generated notification messages to the one or more target recipients using the notification method.

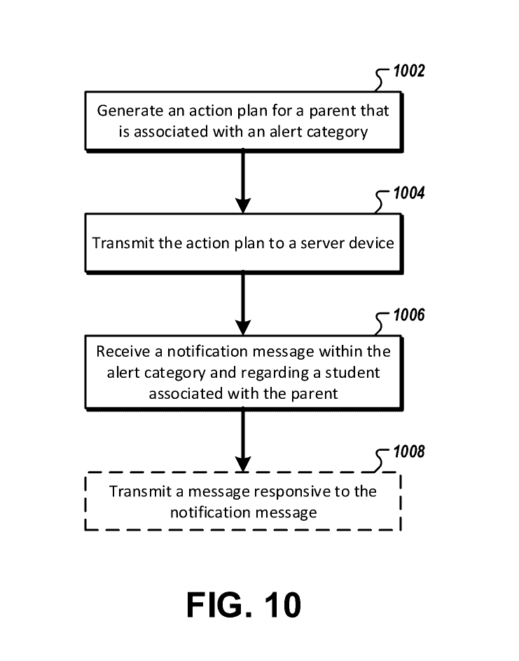

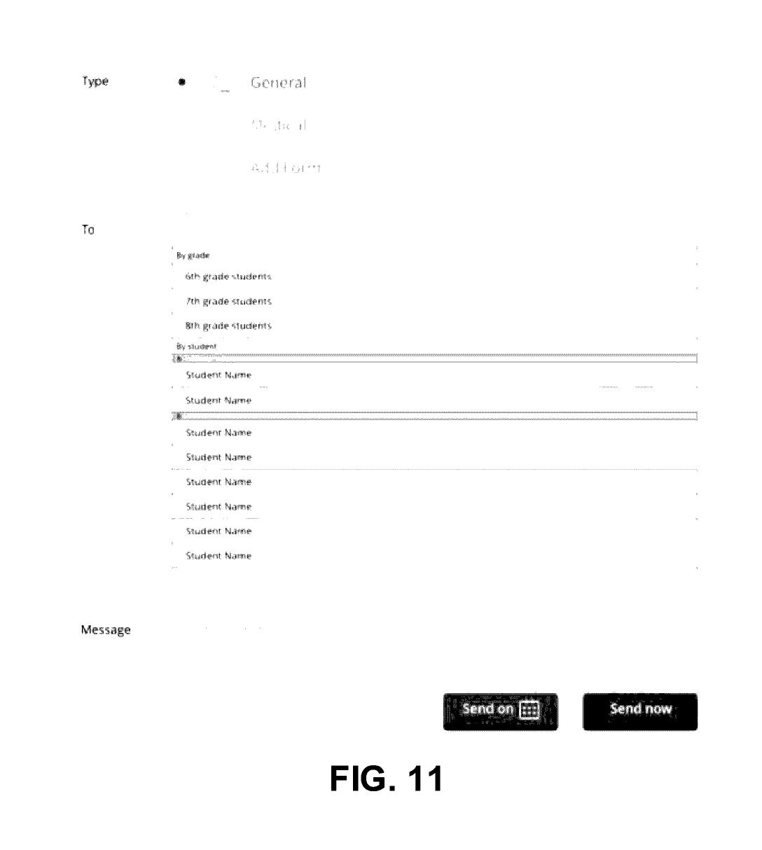

In optional operation 812 the apparatus 200 includes means, such as processor 202, communications circuitry 208, or the like, for receiving one or more transmission from one or more parent devices in response to transmission of the one or more notification messages. The particular responsive transmissions will be discussed in greater detail below in connection with FIG. 10. This operation is optional because it is conceivably possible for none of the parents receiving the notification messages to respond.

Finally, in optional operation 814 the apparatus 200 includes means, such as processor 202, memory 204, input/output circuitry 206, communications circuitry 208, or the like, for taking additional action based on the responsive transmission from the parent device. In an instance in which operation 812 does not occur, operation 814, which follows from operation 812, would also not occur. Accordingly, operation 814 is also optional. In embodiments in which the transmission from the parent device authorizes payment for a student activity, optional operation 814 may include means, such as processor 202, communications circuitry 208, or the like for causing a charge to be applied to an account associated with the parent device. In embodiments in which the transmission from the parent device authorizes performance of a student activity, optional operation 814 may include means, such as memory 204, or the like for storing an indication that a parent associated with the parent device has authorized performance of the student activity. Additionally or alternatively, the apparatus 200 may simply transmit a message indicating one or both of these authorizations have been received, thus letting the educator device cause the charging of an account or storing of the parental authorization.

### Operations Performed by an Educator Device

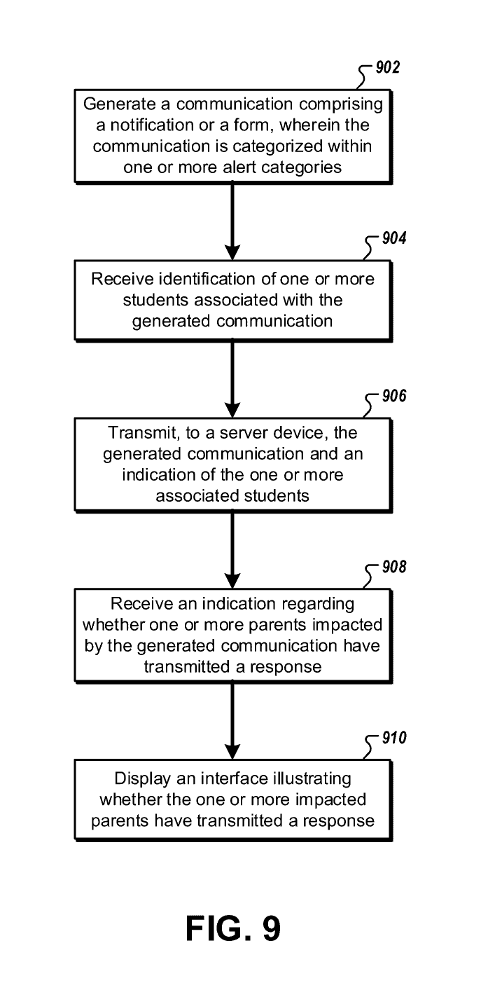

Turning now to FIG. 9, a flowchart is illustrated that contains a series of operations performed by an educator device 110 for facilitating Internet-based communication between an educator and one or more remote parents. The operations illustrated in FIG. 9 may, for example, be performed by, with the assistance of, and/or under the control of an apparatus 300 embodying a parent device 110, and more particularly through the use of one or more of processor 302, memory 304, input/output circuitry 306, communications circuitry 308, and communication generation circuitry 310.

In operation 902 the apparatus 300 includes means, such as communication generation circuitry 310, or the like, for generating a communication. It should be noted that a generated communication may comprise a notification or it may comprise a form, but in any event the communication can be categorized within one or more alert categories. These communications may be generated in a number of ways depending on the nature of the communication and the ability of the host system and/or educator device to capture data amenable to automatic inclusion in a communication. Each of these two types of communications may be generated in different ways.

To generate a notification, communication generation circuitry 310 may cause the apparatus 300 to provide a user interface enabling the educator to manually generate a notification using, for instance, input/output circuitry 306 (as shown, for instance, in FIG. 11). Alternatively, a notification may be automatically generated by the communication generation circuitry 310 of an educator's device based on student-related data received from the host system 102. For instance, if a student gets a particularly high grade on a test or a paper and that grade is uploaded to the host system 102, the uploading of that grade may in some embodiments comprise a triggering event that causes the educator device to automatically generate a communication about this fact for delivery to a parent in accordance with the parent's relevant action plan. Similar automatically generated notifications may indicate other information to a parent regarding a student, such as a missed class, a missed school day, a missed student activity, assuming that information indicating the occurrence of such events is uploaded to the host system 102 and is recognizable to the educator device. While likely classified into a different alert category than general notifications, medical notifications may also be automatically generated based on appropriate data being logged by the host system 102. For instance, if the host system 102 indicates that a child has a fever, that information may be used by the communication generation circuitry 310 of an educator device to automatically generate a communication for delivery to the parent in accordance with a relevant action plan.

The generation of forms may be automated in some instances, but it is more likely that forms, which request parental authorization or payment would be generated relatively infrequently and are thus amenable to device-assisted creation by an educator. In this regard, template versions of forms requesting parental payments or authorizations may initially be created manually by the entity operating the host system 102 or by an educator and uploaded to the host system 102. Once created, these template forms may include fields that can be automatically populated, if desired, such as to enter a relevant child or parent's name in an appropriate signature box, or the like. In certain embodiments, entirely automated generation of forms is contemplated in which the educator device, or information entered into host system 102, prompts automatic form generation. For instance, if a field trip is entered into a school calendar and includes the requisite information to identify the students that are scheduled to attend, the educator device (and in particular the communication generation circuitry 310) may automatically retrieve and populate a relevant template form for distribution to parents in accordance with their respective action plans.

In some embodiments, it should be understood that operation 902 may further include transmission, to the host system 102, of an indication of correlations between the one or more students and one or more parents. The correlations between the one or more students and the one or more parents enables identification of the one or more parents impacted by a generated communication. However, in alternative embodiments, correlations of this nature may already be stored by the host system 102 and would not need to be uploaded by an educator device.

In operation 904 the apparatus 300 includes means, such as input/output circuitry 306, communication generation circuitry 310, or the like, for receiving, from an educator, identification of one or more students associated with the generated communication. For instance, if a communication is generated regarding a student for whom there is an upcoming parent/teacher conference, the communication itself must be generated, but in addition the student who is the subject of the communication must also be identified. As illustrated in FIG. 11, this operation may include the display of a user interface enabling the educator to select groups of students to associate with a particular communication (e.g., the 8^{th} grade student body, the students in a particular 9am math class, etc.).

The generated communications may relate to a number of different activities or requests, some of which are described herein. For instance, notifications may simply provide updates to parents regarding a student's activities throughout the day, week, month, semester, or school year. Notifications may also provide updates regarding disciplinary actions (e.g., detention), transportation-related events (e.g., school bus maintenance problems), school-wide updates (e.g., security-related events, medical events, or other emergency events). Similarly, forms may request signatures authorizing student activities or request payment for various student activities. These student activities may include, for instance, field trips, medical treatment (e.g., immunizations, medicine, medical procedures, or the like), camps, classroom supplies, other classroom expenses (e.g.,teacher gifts), uniforms, athletic equipment, or the like. While not technically student activities, it should be appreciated that forms may also be transmitted requesting payment authorization for various purchases on behalf of a student. For instance, textbooks, supplemental student supplies, or the like, may be offered that can be delivered by the school upon payment authorization by a parent (avoiding the hassle of every parent having to purchase school supplies separately).

As further illustrated in FIG. 11, the user interface may additionally display a “send on” icon that, when selected, enables the selection of a date-based triggering event for the generated communication. For instance, selection of the triggering event may thus comprise selecting a user-defined date that, when detected by the server device, prompts transmission of the notification messages to the one or more parents impacted by the generated communication. To facilitate this process, in embodiments including a user-selectable triggering event feature, transmitting the generated communication and an indication of the one or more students associated with the generated communication includes transmitting the selected triggering event. As noted previously, in some embodiments, triggering events associated with a communication need not be date-based. In such instances, the user interface may enable an educator to define non-date-based triggering events that correspond to the notification as well. For instance, when the educator contemplates that an update to a particular type of data in database 104 comprises a non-date-based triggering event, the user interface may present one or more options (e.g., via a wizard or other intuitive series of prompts) for specifying what type of updates to database 104 will comprise triggering events for the communication.

In operation 906 the apparatus 300 includes means, such as communications circuitry 308, or the like, for transmitting, to a server device, the generated communication and an indication of the one or more students associated with the generated communication. As noted above, when triggering events are selected, these triggering events may be transmitted to the server device in conjunction with the generated communication and the indication of the associated students.

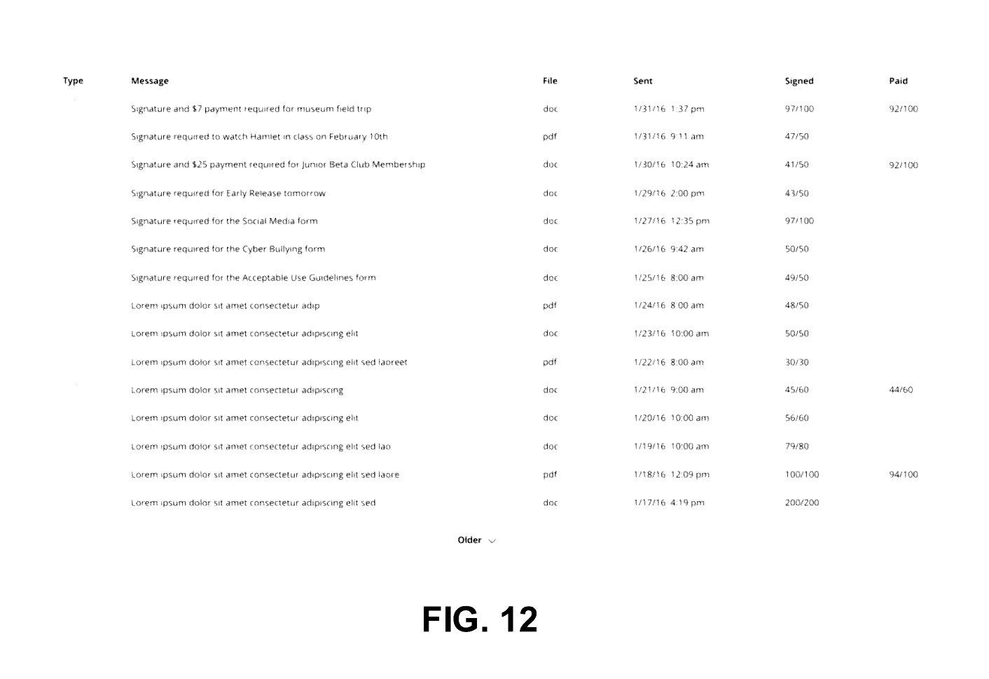

In operation 908 the apparatus 300 includes means, such as input/output circuitry 306, or the like, for receiving an indication regarding whether one or more parents impacted by the generated communication have transmitted a response to the generated communication. As shown in FIG. 12, this indication may comprise a user interface illustrating an alert category (e.g., “type”), a message (e.g., communication), a file type, a date transmitted, and finally, columns indicating a number of recipients who have signed the document, and a number of recipients who have authorized a payment.

In this regard, in operation 910 the apparatus 300 includes means, such as input/output circuitry 306, or the like, for displaying, by the educator device, an interface illustrating whether the one or more parents impacted by the generated communication have transmitted a response to the generated communication. In embodiments in which the communication generated by the educator device had requested payment for a student activity, the interface may further illustrate whether the one or more parents (and/or other individuals) impacted by the generated communication have provided payment for the student activity (as noted above, the “parent devices” need not also be operated by parents, and may be operated by other individuals depending on the nature of the implementation of the system). As one example, a parent may receive a request to pay for a student activity. In another example, a parent and a student may both receive requests to sign a school honor code. As yet another example outside of the educational sphere, in a caretaker embodiment, a legal guardian or other representative may receive a request to pay for a particular discretionary service, such as delivery of flowers on a subject's birthday. Similarly, in embodiments in which the communication generated by the educator device requires authorization for the one or more students to perform a student activity, the interface may further illustrate whether the one or more parents impacted by the generated communication have provided authorization for corresponding students to perform the student activity. When payment is requested or authorization is required and not yet received by one or more parents, additional triggering events for the communication may be established that prompt transmission of reminder notification messages in accordance with the relevant action plans by the non-responsive parents. In this fashion, the educator is relieved of the burden of manually tabulating the parents who have provided authorizations and/or payments and manually attempting to secure the relevant authorization or payment on an ad hoc basis.

### Operations Performed by a Parent Device

Turning now to FIG. 10, a flowchart is illustrated that contains a series of operations performed by a parent device 112 for facilitating Internet-based communication between a parent and one or more remote educators. The operations illustrated in FIG. 10 may, for example, be performed by, with the assistance of, and/or under the control of an apparatus 400 embodying a parent device 112, and more particularly through the use of one or more of processor 402, memory 404, input/output circuitry 406, communications circuitry 408, action plan development circuitry 410, and notification circuitry 412.

In operation 1002 the apparatus 400 includes means, such as action plan development circuitry 410, or the like, for generating, by a first parent device associated with the parent, an action plan for the parent and associated with an alert category. In some embodiments, generating the action plan associated with the alert category may include displaying an action plan generation interface, wherein the action plan generation interface is configured to prompt the user for selection of one or more notification methods for a chosen alert category. Generating the action plan may further include receiving, by the first parent device, selection of a set of notification methods for the chosen alert category, and assembling the action plan, by the processor of the first parent device. The generated action plan generated in this fashion will then include the set of notification methods for the chosen alert category.

In operation 1004 the apparatus 400 includes means, such as processor 402, communications circuitry 408, or the like, for transmitting, by communications circuitry of the first parent device, the action plan to a server device.

In operation 1006 the apparatus 400 includes means, such as notification circuitry 412, or the like, for receiving, by a second parent device associated with the parent, a notification message based on a communication within the alert category and about a student associated with the parent, wherein the notification message is transmitted in response to generation of a communication by an educator. It should be noted that the first parent device and the second parent device may represent the same parent device or different parent devices. For instance, the first parent device may be a parent's desktop computer at home or at work, where user interface interactions are readily performed on a large monitor. The second parent device may then be the parent's smartphone, which is ideally suited for receiving notification messages, but less ideal for the original generation of action plans.

In optional operation 1008 the apparatus 400 includes means, such as processor 402, input/output circuitry 406, communications circuitry 408, notification circuitry 412, or the like, for generating, by the second parent device, a message responsive to the received notification message, and transmitting, by the second parent device and to the server device, the message responsive to the received notification message. It should be understood that, in some embodiments, the message responsive to the received notification message authorizes payment for a student activity identified in the received notification message. Additionally or alternatively, the message responsive to the received notification message may authorize performance of a student activity identified in the received notification message.

As described above, example embodiments provide a platform enabling educators (e.g., teachers and administrators) and parents to communicate electronically using the modes of communication they prefer. By enabling fast, direct, and hassle-free communication between educators and parents, educators are freed from the administrative burdens accompanying traditional methods for securing authorizations and notifying parents, enabling them to focus time and attention to other tasks. By increasing both the productivity and efficiency of educators, example embodiments described above address a core problem facing primary and secondary educational institutions today.

FIGS. 8, 9, and 10 illustrate flowcharts describing the operation of an apparatus, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory of an apparatus employing an embodiment of the present invention and executed by a processor of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware and computer instructions.

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for facilitating Internet-based communication between educators and parents who are located remotely from each other, the method comprising:
populating a database with
one or more communications associated with one or more students and categorized within one or more alert categories, wherein each of the one or more communications comprises a notification or a form,
one or more action plans associated with one or more parents and at least one of the one or more alert categories, and
correlations of each of the one or more students to at least one of the one or more parents;
detecting, by a processor, occurrence of a triggering event corresponding to a particular communication in the database;
identifying one or more parents impacted by the particular communication;
retrieving one or more action plans based on the one or more parents impacted by the particular communication and an alert category into which the particular communication is categorized; and
causing, by the processor, transmission of one or more notification messages based on the retrieved one or more action plans.

2. The method of claim 1, further comprising:
receiving one or more transmission from one or more parent devices in response to transmission of the one or more notification messages.

3. The method of claim 2, further comprising:
in an instance in which a transmission from a parent device authorizes payment for a student activity, causing a charge to be applied to an account associated with the parent device.

4. The method of claim 2, further comprising:
in an instance in which a transmission from a parent device authorizes performance of a student activity, storing an indication that a parent associated with the parent device has authorized performance of the student activity.

5. The method of claim 1, wherein populating the database comprises:
receiving, the one or more communications from one or more educator devices;
identifying triggering events corresponding to the received one or more communications;
storing, in the database, the received one or more communications, one or more indications of the one or more students associated with the one or more communications, one or more indications of the alert categories within which the one or more communications are categorized, and one or more indications of the identified triggering events corresponding to the received one or more communications;
receiving the one or more action plans from one or more parent devices;
storing the one or more action plans in the database in association with the one or more parents and the at least one of the one or more alert categories;
receiving the correlations of the one or more students to at least one of the one or more parents from one or more educator devices; and
storing the received correlations in the database.

6. The method of claim 5, wherein receiving an action plan includes:
causing a parent device to display an action plan generation interface, wherein the action plan generation interface is configured to prompt the parent device to select one or more notification methods for a chosen alert category; and
receiving, from the parent device, selection of a set of notification methods for the chosen alert category,
wherein the set of notification methods for the chosen alert category comprises the action plan.

7. The method of claim 1, wherein a triggering event comprises at least one of:
occurrence of a user-defined date;
occurrence of a date that is a predefined number of days after the user-defined date; or
occurrence of a date a predefined number of days before a student activity requiring parent authorization.

8. The method of claim 1, wherein detecting the occurrence of the triggering event corresponding to the particular communication comprises:
retrieving a current date;
identifying whether the current date comprises a triggering event corresponding to any communication stored in the database; and
determining that the current date comprises a triggering event corresponding to the particular communication.

9. The method of claim 1, wherein identifying the one or more parents impacted by the particular communication comprises:
retrieving the one or more students associated with the particular communication; and
identifying the one or more parents impacted by the particular communication using the correlations of the one or more students to at least one of the one or more parents.

10. The method of claim 1, wherein causing transmission of the one or more notification messages includes, for each of the retrieved one or more action plans:
identifying, from the action plan, a set of notification methods; and
for each notification method of the set of notification methods,
identifying, from the action plan, one or more target recipients for the notification method,
generating notification messages for the one or more target recipients based on the particular communication, and
transmitting the generated notification messages to the one or more target recipients using the notification method.

11. An apparatus for facilitating Internet-based communication between educators and parents who are located remotely from each other, the apparatus comprising at least one processor and at least one memory storing computer-executable instructions, that, when executed by the at least one processor, cause the apparatus to:
populate a database with
one or more communications associated with one or more students and categorized within one or more alert categories, wherein each of the one or more communications comprises a notification or a form,
one or more action plans associated with one or more parents and at least one of the one or more alert categories, and
correlations of each of the one or more students to at least one of the one or more parents;
detect occurrence of a triggering event corresponding to a particular communication in the database;
identify one or more parents impacted by the particular communication;
retrieve one or more action plans based on the one or more parents impacted by the particular communication and an alert category into which the particular communication is categorized; and
cause transmission of one or more notification messages based on the retrieved one or more action plans.

12. The apparatus of claim 11, wherein the computer-executable instructions, when executed by the at least one processor, further cause the apparatus to:
receive one or more transmission from one or more parent devices in response to transmission of the one or more notification messages.

13. The apparatus of claim 12, wherein the computer-executable instructions, when executed by the at least one processor, further cause the apparatus to:
in an instance in which a transmission from a parent device authorizes payment for a student activity, cause a charge to be applied to an account associated with the parent device; or
in an instance in which a transmission from a parent device authorizes performance of a student activity, store an indication that a parent associated with the parent device has authorized performance of the student activity.

14. (canceled)

15. The apparatus of claim 11, wherein the computer-executable instructions, when executed by the at least one processor, cause the apparatus to populate the database by:
receiving, the one or more communications from one or more educator devices;
identifying triggering events corresponding to the received one or more communications;
storing, in the database, the received one or more communications, one or more indications of the one or more students associated with the one or more communications, one or more indications of the alert categories within which the one or more communications are categorized, and one or more indications of the identified triggering events corresponding to the received one or more communications;
receiving the one or more action plans from one or more parent devices;
storing the one or more action plans in the database in association with the one or more parents and the at least one of the one or more alert categories;
receiving the correlations of the one or more students to at least one of the one or more parents from one or more educator devices; and
storing the received correlations in the database.

16. The apparatus of claim 15, wherein the computer-executable instructions, when executed by the at least one processor, cause the apparatus to receive an action plan by:
causing a parent device to display an action plan generation interface, wherein the action plan generation interface is configured to prompt the parent device to select one or more notification methods for a chosen alert category; and
receiving, from the parent device, selection of a set of notification methods for the chosen alert category,
wherein the set of notification methods for the chosen alert category comprises the action plan.

17. The apparatus of claim 11, wherein a triggering event comprises at least one of:
occurrence of a user-defined date;
occurrence of a date that is a predefined number of days after the user-defined date; or
occurrence of a date a predefined number of days before a student activity requiring parent authorization.

18. The apparatus of claim 11, wherein the computer-executable instructions, when executed by the at least one processor, further cause the apparatus to detect the occurrence of the triggering event corresponding to the particular communication by:
retrieving a current date;
identifying whether the current date comprises a triggering event corresponding to any communication stored in the database; and
determining that the current date comprises a triggering event corresponding to the particular communication.

19. The apparatus of claim 11, wherein the computer-executable instructions, when executed by the at least one processor, further cause the apparatus to identify the one or more parents impacted by the particular communication by:
retrieving the one or more students associated with the particular communication; and
identifying the one or more parents impacted by the particular communication using the correlations of the one or more students to at least one of the one or more parents.

20. The apparatus of claim 11, wherein the computer-executable instructions, when executed by the at least one processor, further cause the apparatus to cause transmission of the one or more notification messages by, for each of the retrieved one or more action plans:
identifying, from the action plan, a set of notification methods; and
for each notification method of the set of notification methods,
identifying, from the action plan, one or more target recipients for the notification method,
generating notification messages for the one or more target recipients based on the particular communication, and
transmitting the generated notification messages to the one or more target recipients using the notification method.

21. At least one non-transitory computer-readable storage medium for facilitating Internet-based communication between educators and parents who are located remotely from each other, the at least one non-transitory computer-readable storage medium storing computer-executable instructions that, when executed, cause an apparatus to:
populate a database with
one or more communications associated with one or more students and categorized within one or more alert categories, wherein each of the one or more communications comprises a notification or a form,
one or more action plans associated with one or more parents and at least one of the one or more alert categories, and
correlations of each of the one or more students to at least one of the one or more parents;
detect occurrence of a triggering event corresponding to a particular communication in the database;
identify one or more parents impacted by the particular communication;
retrieve one or more action plans based on the one or more parents impacted by the particular communication and an alert category into which the particular communication is categorized; and
cause transmission of one or more notification messages based on the retrieved one or more action plans.

22-75. (canceled)
